(19) United States
(12) Patent Application Publication
(10) Pub. No.: US 2022/0285461 A1
(43) Pub. Date: Sep. 8, 2022

(54) Display Device and Electronic Device

(71) Applicant: Semiconductor Energy Laboratory Co., Ltd., Kanagawa-ken (JP)

(72) Inventors: Ryo Hatsumi, Hadano, Kanagawa (JP); Taisuke KAMADA, Niiza, Saitama (JP); Kazunori WATANABE, Machida, Tokyo (JP); Daisuke KUBOTA, Atsugi, Kanagawa (JP)

(73) Assignee: Semiconductor Energy Laboratory Co., Ltd., Kanagawa-ken (JP)

(21) Appl. No.: 17/632,340

(22) PCT Filed: Jul. 27, 2020
(86) PCT No.: PCT/IB2020/057050

§ 371 Date: Feb. 2, 2022

(30) Foreign Application Priority Data
Aug. 8, 2019 (JP) 2019-146658

(51) Int. Cl. H01L 27/32; G06F 21/32

(52) U.S. Cl. CPC H01L 27/3227; H01L 27/323; G06F 21/32

(57) ABSTRACT

A display device having both a function of a touch sensor and a function of fingerprint recognition is provided. The display device includes a first display region and a second display region. The first display region and the second display region are provided in contact with each other. The first display region includes a plurality of first light-emitting elements and a plurality of first photodetectors. The second display region includes a plurality of second light-emitting elements and a plurality of second photodetectors. The first photodetector has a function of receiving first light emitted from the first light-emitting element. The second photodetector has a function of receiving second light emitted from the second light-emitting element. The first light-emitting elements and the first photodetectors are arranged in a matrix in the first display region. The second light-emitting elements and the second photodetectors are arranged in a matrix in the second display region. The second photodetectors are arranged in a higher density than the first photodetectors.

### TECHNICAL FIELD

One embodiment of the present invention relates to a display device. One embodiment of the present invention relates to an electronic device.

Note that one embodiment of the present invention is not limited to the above technical field. Examples of the technical field of one embodiment of the present invention disclosed in this specification and the like include a semiconductor device, a display device, a light-emitting device, a power storage device, a memory device, an electronic device, a lighting device, an input device, an input/output device, a driving method thereof, and a manufacturing method thereof. A semiconductor device generally means a device that can function by utilizing semiconductor characteristics.

### BACKGROUND ART

In recent years, information terminal devices, for example, mobile phones such as smartphones, tablet information terminals, and laptop PCs (personal computers) have been widely used. Such information terminal devices often include personal information or the like, and thus various authentication technologies for preventing abuse have been developed.

For example, Patent Document 1 discloses an electronic device including a fingerprint sensor in a push button switch portion.

### REFERENCE

### Patent Document

[Patent Document 1] United States Published Patent Application No. 2014/0056493

### SUMMARY OF THE INVENTION

### Problems to be Solved by the Invention

An object of one embodiment of the present invention is to provide a display device having a photosensing function. Another object is to provide a display device capable of a biometric authentication function typified by fingerprint authentication. Another object is to provide a display device having both a touch sensor function and a fingerprint authentication function.

Another object of one embodiment of the present invention is to provide a highly convenient electronic device. Another object is to provide a multifunctional electronic device. Another object is to reduce the number of components of an electronic device. Another object is to provide an electronic device with a high proportion of a display area. Another object is to provide a user-friendly fingerprint authentication method of an electronic device. Another object is to provide a fingerprint authentication system of an electronic device which makes users feel less inconvenient when fingerprint authentication is performed.

Note that the description of these objects does not preclude the existence of other objects. One embodiment of the present invention does not have to achieve all these objects. Objects other than these can be derived from the description of the specification, the drawings, the claims, and the like.

### Means for Solving the Problems

One embodiment of the present invention is a display device including a first display region and a second display region. The first display region and the second display region are provided in contact with each other. The second display region includes a plurality of second light-emitting elements and a plurality of second photodetectors. The first display region includes a plurality of first light-emitting elements and a plurality of first photodetectors. The first photodetectors have a function of receiving first light emitted from the first light-emitting elements. The second photodetectors have a function of receiving second light emitted from the second light-emitting elements. The first light-emitting elements and the first photodetectors are arranged in a matrix in the first display region. The second light-emitting elements and the second photodetectors are arranged in a matrix in the second display region. The second photodetectors are provided at a higher density than that of the first photodetectors.

In the above, the first light-emitting elements are preferably provided at a higher density than that of the second light-emitting elements.

In the above, the first photodetector and the second photodetector preferably includes active layers containing the same organic compound. In addition, the first light-emitting element and the second light-emitting element preferably include light-emitting layers containing the same organic compound.

In the above, each of the first light-emitting element and the second light-emitting element includes a stacked structure in which a first pixel electrode, an active layer, and a common electrode are stacked. In addition, each of the first light-emitting element and the second light-emitting element includes a stacked structure in which a second pixel electrode, a light-emitting layer, and the common electrode are stacked. At this time, the first pixel electrode and the second pixel electrode are preferably provided on the same surface and the active layer and the light-emitting layer thereof preferably contain different organic compounds.

In the above, the common electrode preferably has a function of being supplied with a first potential, the first pixel electrode preferably has a function of being supplied with a second potential lower than the first potential, and the second pixel electrode preferably has a function of being supplied with a third potential higher than the first potential.

Another embodiment of the present invention is an electronic device including any of the above display devices and a housing. The housing includes a first surface and a second surface. The first surface and the second surface are continuously provided with each other and have different normal directions. The first display region is provided along the first surface and the second display region is provided along the second surface.

In the above, the second surface preferably includes a curving surface.

Another embodiment of the present invention is an electronic device including any of the above display devices and a housing. The housing includes a bezel surrounding the first display region and the second display region. In this case, the second display region is preferably provided along part of the inner contour of the bezel.

Another embodiment of the present invention is an electronic device including any of the above display devices and a housing. The housing includes a bezel surrounding the first display region and the second display region. The inner contour of the bezel has a quadrangular shape or a quadrangular shape with rounded corners. In this case, the second display region is preferably provided in contact with adjacent two sides of the inner contour.

In the above, the first display region preferably has a function of capturing an image of a fingerprint, and the second display region preferably has a function of a touch sensor.

### Effect of the Invention

With one embodiment of the present invention, a display device having a photodetection function can be provided. A display device capable of a biometric authentication function typified by fingerprint authentication can be provided. A display device having both a touch sensor function and a fingerprint authentication function can be provided.

According to one embodiment of the present invention, a highly convenient electronic device can be provided. A multi-functional electronic device can be provided. The number of components of the electronic device can be reduced. An electronic device having a high proportion of a display area can be provided. A user-friendly fingerprint recognition method for an electronic device can be provided. An electronic device which less bothers a user when fingerprint recognition is performed can be provided.

Note that the description of these effects does not preclude the existence of other effects. One embodiment of the present invention does not have to have all of these effects. Effects other than these can be derived from the description of the specification, the drawings, the claims, and the like.

### BRIEF DESCRIPTION OF THE DRAWINGS

FIG. 1A is a diagram illustrating a structure example of an electronic device. FIG. 1B to FIG. 1E are diagrams illustrating configuration examples of a pixel.

FIG. 2A to FIG. 2D are configuration examples of a pixel.

FIG. 3A to FIG. 3C are diagrams illustrating configuration examples of a pixel.

FIG. 4A and FIG. 4B are diagrams illustrating configuration examples of a pixel.

FIG. 5A and FIG. 5B are diagrams illustrating configuration examples of a pixel.

FIG. 6A and FIG. 6B are diagrams illustrating a structure example of an electronic device.

FIG. 7A and FIG. 7B are diagrams illustrating a structure example of an electronic device.

FIG. 8A and FIG. 8B are diagrams illustrating a structure example of an electronic device.

FIG. 9A, FIG. 9B, and FIG. 9D are diagrams illustrating configuration examples of a display device. FIG. 9C and FIG. 9E are diagrams illustrating examples of images.

FIG. 10A to FIG. 10C are diagrams illustrating a structure example of a display device.

FIG. 11A to FIG. 11D are diagrams illustrating structure examples of a display device.

FIG. 12A to FIG. 12D are diagrams illustrating structure examples of a display device.

FIG. 13A to FIG. 13C are views illustrating a structure example of a display device.

FIG. 14A and FIG. 14B are diagrams illustrating structure examples of a display device.

FIG. 15A to FIG. 15C are views illustrating a structure example of a display device.

FIG. 16 is a diagram illustrating a structure example of a display device.

FIG. 17 is a diagram illustrating a structure example of a display device.

FIG. 18A and FIG. 18B are diagrams illustrating a structure example of a display device.

FIG. 19A and FIG. 19B are diagrams illustrating a structure example of a display device.

FIG. 20 is a view illustrating a structure example of a display device.

FIG. 21A and FIG. 21B are diagrams illustrating structure examples of pixel circuits.

### MODE FOR CARRYING OUT THE INVENTION

Hereinafter, embodiments are described with reference to the drawings. Note that the embodiments can be implemented in many different modes, and it is readily understood by those skilled in the art that modes and details thereof can be changed in various ways without departing from the spirit and scope thereof. Thus, the present invention should not be construed as being limited to the following description of the embodiments.

Note that in structures of the invention described below, the same portions or portions having similar functions are denoted by the same reference numerals in different drawings, and a description thereof is not repeated. Furthermore, the same hatch pattern is used for the portions having similar functions, and the portions are not especially denoted with reference numerals in some cases.

Note that in each drawing described in this specification, the size, the layer thickness, or the region of each component is exaggerated for clarity in some cases. Therefore, they are not limited to the illustrated scale.

Note that in this specification and the like, the ordinal numbers such as “first” and “second” are used in order to avoid confusion among components and do not limit the number.

### Embodiment 1

In this embodiment, a display device of one embodiment of the present invention and an electronic device including a display device are described.

The display device of one embodiment of the present invention includes a plurality of display elements and a plurality of photodetectors (also referred to as light-receiving devices). The display element is preferably a light-emitting element (also referred to as a light-emitting device). The photodetector is preferably a photoelectric conversion element.

The display device has a function of displaying an image on the display surface side by the display elements arranged in a matrix.

The display device can take an image of an object that touches or approaches a display surface. Part of light emitted from the display element is reflected by the object and the reflected light enters the photodetector, for example. The photodetector can output an electric signal in accordance with the intensity of incident light. Thus, the display device including the plurality of photodetectors arranged in a matrix can obtain the positional data or shape of the object as data (this process is also referred to as imaging). That is, the display device can function as an image sensor panel, a touch sensor panel, or the like.

The display device includes a structure in which the first display region (also referred to as first display portion) and a second display region (also referred to as second display portion) are adjacently provided (or in contact with each other). First display elements and the first photodetectors are arranged in a matrix in the first display region. Second display elements and the second photodetectors are arranged in a matrix in the second display region. The first display elements and the second display elements can be formed in the same process.

Here, the second photodetectors provided in the second display region are provided at a higher density than that of the first photodetectors provided in the first display region. Thus, the second display region can capture an image whose resolution is higher than an image captured with the first display region. On the other hand, the first display region can have a shorter imaging period with lower resolution than that of the second display region and can operate with high speed.

For example, the second display region can capture a high resolution image; the second display region can be suitably used in imaging for biometric authentication such as fingerprint recognition or palm print recognition. On the other hand, the first display region can operate with high speed; the first display region can be suitably used for a touch sensor panel (including proximity sensor panel and near touch sensor panel). Note that the second display region can have a function of a touch sensor panel.

A display device including the first display region and the second display region can be included in an electronic device. At this time, part of the display portion of the electronic device with the second display region can have a function of fingerprint recognition and the other part thereof with the first display region can have a function of a touch panel. With such a structure, the two functions can be obtained with one display device; thus, the number of components can be reduced and the display device can easily be a multi-functional device.

When the display device of one embodiment of the present invention is included in a display portion of an electronic device, the second region having a function of fingerprint recognition is preferably provided in contact with part of the contour of the display portion. For example, the second region is provided in the position where user's fingers naturally touch when a user holds the electronic device, whereby the electronic device can recognize the user without the user's notice on holding the electronic device. Therefore, a highly useful electronic device can be realized without compromising safety. A position where user's fingers naturally touch is, for example, a region along part of the inner contour of the bezel surrounding the display portion. In addition, the electronic device preferably has a structure including the display portion from a top surface of the housing to a lateral surface and the second region is preferably provided in the lateral surface.

Here, in this specification and the like, in a plan view of a frame-like object, the outside contour is referred to as an outer contour and the inside contour is referred to as the inner contour. The frame-like object means an object having at least one opening inside the contour (outer contour) of the object in a plan view. In other words, the inner contour means a closed curve along the edge of an opening of a frame-like object in a plan view.

Here, in the case where a light-emitting element is used as the display element, an EL element such as an OLED (Organic Light Emitting Diode) or a QLED (Quantum-dot Light Emitting Diode) is preferably used. As a light-emitting substance included in the EL element, a substance which emits fluorescence (fluorescent material), a substance which emits phosphorescence (phosphorescent material), a substance which exhibits thermally activated delayed fluorescence (thermally activated delayed fluorescent (TADF) material), an inorganic compound (e.g., quantum dot material), and the like can be given. Alternatively, an LED such as a micro-LED (Light Emitting Diode) can be used as the light-emitting element.

As the photodetector, a pn photodiode or a pin photodiode can be used, for example. The photodetector functions as a photoelectric conversion element that senses light incident on the photodetector and generates charge. The amount of generated charge in the photoelectric conversion element is determined depending on the amount of incident light. It is particularly preferable to use an organic photodiode including a layer containing an organic compound as the photodetector. An organic photodiode, which is easily made thin, lightweight, and large in area and has a high degree of freedom for shape and design, can be used in a variety of display devices.

The light-emitting element can have a stacked-layer structure including a light-emitting layer between a pair of electrodes, for example. The photodetector can have a stacked-layer structure including an active layer between a pair of electrodes. A semiconductor material can be used for the active layer of the photodetector. For example, an inorganic semiconductor material such as silicon can be used.

An organic compound is preferably used for the active layer of the photodetector. In that case, one electrode of the light-emitting element and one electrode of the photodetector (the electrodes are also referred to as pixel electrodes) are preferably provided on the same plane. It is further preferable that the other electrode of the light-emitting element and the other electrode of the photodetector be an electrode (also referred to as a common electrode) formed using one continuous conductive layer. It is still further preferable that the light-emitting element and the photodetector include a common layer. Thus, the manufacturing process of the light-emitting element and the photodetector can be simplified as part of manufacturing steps can be in common, so that the manufacturing cost can be reduced and the manufacturing yield can be increased.

More specific examples are described below with reference to drawings.

### [Structure Example 1 of Electronic Device]

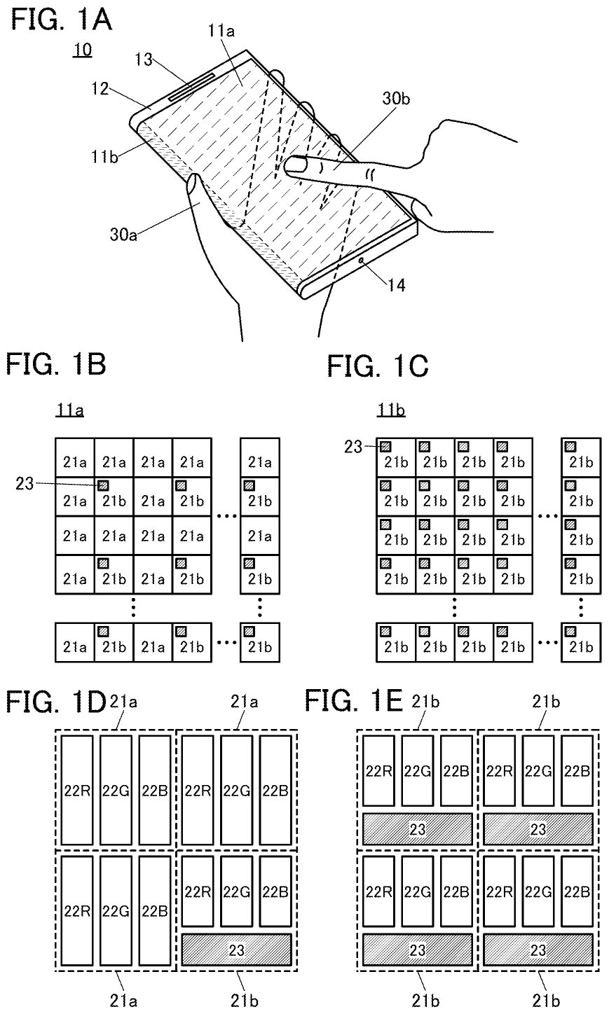

FIG. 1A is a schematic diagram of an electronic device 10 including the display device of one embodiment of the present invention.

The electronic device 10 includes a display portion 11a, a display portion 11b, a housing 12, a speaker 13, a microphone 14, and the like. The electronic device 10 can be used as a portable information terminal. The electronic device 10 can be used as a smartphone, for example.

The housing 12 has a plate-like shape. The display portion 11a is provided along a first surface, which is a top surface of the housing 12. The display portion 11b is provided along a second surface of the housing 12, or one side surface of the housing 12. Here, it is preferable that the second surface provided with the display portion 11b of the housing 12 be continuous with the first surface where the display portion 11a is provided and have a curving surface. It can be said that the normal direction of the display portion 11a provided on the first surface of the housing 12 and the normal direction of the display portion 11b provided on the second surface of the housing 12 are different from each other. The display portion 11a and the display portion 11b are continuously provided.

The display portion 11a functions as a touch panel and has a function of displaying an image and a function of detecting a touch operation (including near touch operation). The display portion 11a can also be referred to as a main screen.

The display portion 11b has a function of displaying an image and a function of capturing an image such as a fingerprint or the like. The display portion 11b may have a function of a touch panel like the display portion 11a. The display portion 11b can also be referred to as a sub-screen.

FIG. 1A illustrates an example in which a user holds the electronic device 10 and operates the display portion 11a with a finger 30b.

The display portion 11b is provided in a position where a finger 30a naturally touches when a user holds the housing 12. In this case, the electronic device 10 can obtain (image) the fingerprint of the finger 30a touching the display portion 11b and perform fingerprint recognition operation. Accordingly, a user can perform a recognition operation without noticing it at the same time when the user holds the electronic device 10. Therefore, at the point when a user takes the electronic device 10 by hand and looks at its screen, the recognition has already been finished, the device has been unlocked, and the electronic device is ready to use; thus, the electronic device can be highly safe and convenient.

Note that in the structure illustrated in FIG. 1A, the display portion 11b is provided in the position which the finger 30a of the left hand touches; however, the structure is not limited thereto, and may be provided in the position which a finger of the right hand touches. Different structures of the electronic device are described later.

### [Pixel Configuration Example]

### Configuration Example 1

FIG. 1B illustrates a configuration example of pixels included in the display portion 11a. The display portion 11a includes a plurality of pixels 21a and a plurality of pixels 21b. FIG. 1C illustrates a configuration example of pixels included in the display portion 11b. The display portion 11b includes a plurality of pixels 21b. The pixel 21b is a pixel including a photodetector 23.

In the display portion 11a, the pixels 21a and the pixels 21b are arranged in a matrix. In FIG. 1B, three pixels 21a and one pixel 21b is included in 2×2 pixels. The display portion 11a has a structure in which units each of which consists of 2×2 pixels are arranged in a matrix.

Note that one unit does not necessarily include 2×2 pixels. For example, one unit may be consisted of a×b pixels (a and b are integers more than or equal to 2 independent from each other). The number of pixels arranged in the vertical direction may be different from the number of pixels arranged in the horizontal direction in one unit.

In the case where the display portion 11a is used as a touch panel, the arrangement pitches of the pixels 21b in the display portion 11a in the vertical direction and the horizontal direction (i.e., the widths of one unit in the vertical direction and the horizontal direction) are each preferably 20 mm or less, 10 mm or less, 8 mm or less, or 6 mm or less and are each preferably twice or more as large as the width of the pixel 21a or the pixel 21b, whereby a sensitive touch panel can be made. Note that depending on the configuration of the driver circuit of a touch sensor, the arrangement pitch of the pixels 21b may be more than 20 mm and less than or equal to 25 mm, or less than or equal to 30 mm. The arrangement pitch of the pixels 21b is wider than that of the pixels 21a, which shortens the time for reading, whereby a touch panel can readily operate with high speed and a smooth touch operation can be performed.

FIG. 1D illustrates 2×2 pixels of the display portion 11a. The pixel 21a includes a display element 22R, a display element 22G, and a display element 22B. In FIG. 1D, the display elements 22R, the display elements 22G, and the display elements 22B are arranged in respective columns (arranged in a stripe pattern). The pixel 21b includes the display element 22R, the display element 22G, the display element 22B, and the photodetector 23. In FIG. 1D, the display elements 22R, the display elements 22G, and the display elements 22B are arranged in respective columns and the photodetector 23 is positioned therebelow.

Note that the display element 22R, the display element 22G, and the display element 22B are collectively referred to as a display element 22 in some cases.

FIG. 1E illustrates 2×2 pixels in the display portion 11b. Here is shown the case where the pixels 21b included in the display portion 11b has a structure similar to that in the display portion 11a.

The structures of FIG. 1B to FIG. 1E illustrate examples in which the display portion 11a and the display portion 11b include the display elements 22 with the same resolution. Thus, the display portion 11a and the display portion 11b can display an image at the same resolution. Since the display portion 11a can be used as a main display surface, the display portion 11a preferably has the same resolution as the display portion 11b or a higher resolution than the display portion 11b.

By contrast, when the photodetector 23 is focused on, the display portion 11b has a configuration in which the photodetectors 23 are arranged at a higher density than that of the display portion 11a. Thus, the display portion 11b can capture an image whose resolution is higher than that of the display portion 11a.

For example, the resolution (also referred to as arrangement density) of the photodetectors 23 in the display portion 11b is preferably equal to or higher than the resolution of the display element 22 in the display portion 11b. Thus, an extremely high resolution image can be captured; it is suitable for fingerprint recognition and the like.

The resolution of the photodetectors 23 in the display portion 11b can be 100 ppi or more, preferably 200 ppi or more, further preferably 300 ppi or more, and still further preferably 400 ppi or more, and 2000 ppi or less or 1000 ppi or less. In particular, the photodetectors 23 are provided with a resolution of 200 ppi or more and 500 ppi or less, preferably 300 ppi or more and 500 ppi or less, so that the photodetectors can be suitably used for capturing images of fingerprints. The resolution of the photodetectors 23 may be more than 2000 ppi, but when the resolution of the photodetectors 23 is too high, imaging and recognition processing take longer time, which lessens convenience.

Note that the pixel structure is not limited thereto, and a variety of arrangement methods can be employed. An example of a structure of a pixel which is different from the above will be described below.

### Configuration Example 2

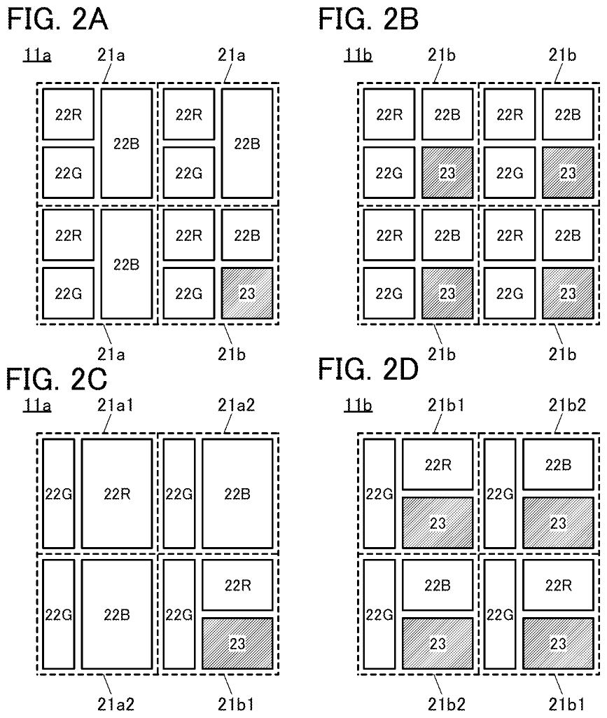

FIG. 2A and FIG. 2B illustrate configuration examples of pixels included in the display portion 11a and the display portion 11b. The display portion 11a includes the pixels 21a and the pixel 21b. The display portion 11b includes pixels 21b.

In the pixel 21a, the display elements 22R and the display elements 22G are alternately arranged in the vertical direction. The display element 22B is provided in the horizontal direction to the display element 22R and the display element 22G. FIG. 2A illustrates an example in which the area of the display element 22B is larger than those of the other display elements, but the display element 22R or the display element 22G may have a larger area than the other elements, as appropriate.

The second pixel 21b includes the display element 22R, the display element 22G, the display element 22B, and the photodetector 23. The display element 22R and the display element 22B are arranged in the horizontal direction, and the display element 22G and the photodetector 23 are arranged in the horizontal direction therebelow. Note that the positions of the display element 22R, the display element 22G, the display element 22B, and the photodetector 23 can be interchanged as appropriate.

### Configuration Example 3

FIG. 2C and FIG. 2D illustrate configuration examples of pixels included in the display portion 11a and the display portion 11b. The display portion 11a includes a pixel 21a1, a pixel 21a2, and a pixel 21b1. The display portion 11b includes the pixels 21b1 and the pixels 21b2.

The pixel 21a1 includes the display element 22G and the display element 22R arranged side by side in the horizontal direction. The pixel 21a2 includes the display element 22G and the display element 22B arranged side by side in the horizontal direction. Here, the display element 22R and the display element 22B have larger areas than the display element 22G.

The pixel 21b1 includes the display element 22G, the display element 22R, and the photodetector 23. The display element 22R and the photodetector 23 are arranged in the vertical direction. The pixel 21b2 includes the display element 22G, the display element 22B, and the photodetector 23. The display element 22G and the photodetector 23 are arranged in the vertical direction.

Although FIG. 2C illustrates an example in which the display portion 11a includes the pixel 21b1, the display portion 11a may include the pixel 21b2 or may include both the pixel 21b1 and the pixel 21b2.

### Configuration Example 4

Although the above example illustrates that the pixel including the photodetector 23 (e.g., pixel 21b) includes the photodetector 23 in addition to the three display elements, a configuration can be employed in which one of the three display elements is replaced with the photodetector 23.

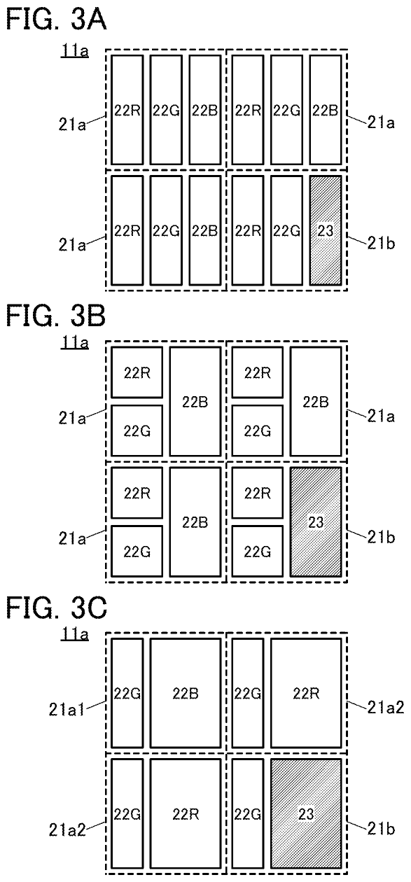

FIG. 3A to FIG. 3C illustrate examples of pixels which can be provided in the display portion 11a.

The pixel 21a illustrated in FIG. 3A has the same configuration as the pixel 21a illustrated in FIG. 1D. The pixel 21b illustrated in FIG. 3A includes the photodetector 23 instead of the display element 22B out of the three display elements of the pixel 21a.

The pixel 21a illustrated in FIG. 3B has the same configuration as the pixel 21a illustrated in FIG. 2A. The pixel 21b illustrated in FIG. 3B includes the photodetector 23 instead of the display element 22B out of the three display elements of the pixel 21a.

The pixel 21a1 and the pixel 21a2 illustrated in FIG. 3C have the same configurations as the pixel 21a1 and the pixel 21a2 illustrated in FIG. 2C, respectively. The pixel 21b illustrated in FIG. 3C includes the photodetector 23 instead of the display element 22B out of the two display elements of the pixel 21a1

With the configurations illustrated in FIG. 3A to FIG. 3C, the areas of the photodetector 23 included in the pixel 21b can be increased, which can improve the sensitivity.

Note that in the configuration illustrated here, the display element 22B is not included in the pixel 21b including the photodetector 23; thus, when an image is displayed, data of luminance may be partly lacked. In this case, it is preferable that the display elements 22B included in the pixels surrounding the pixel 21b be driven to compensate for the display luminance necessary to be exhibited by the pixel 21b. Consequently, an image with no unnaturalness can be displayed.

### Structure Example 5

The display portion 11b functions as a sub-screen whereas the display portion 11a functions as a main screen; a full-color display is not always needed for the display portion 11b in some cases. A usage method in which the display portion 11b is specialized in a capturing function of images of fingerprints or the like and does not display an image. In this case, the pixels included in the display portion 11b can have configurations in which photodetectors and one or more display elements functioning as light sources are included.

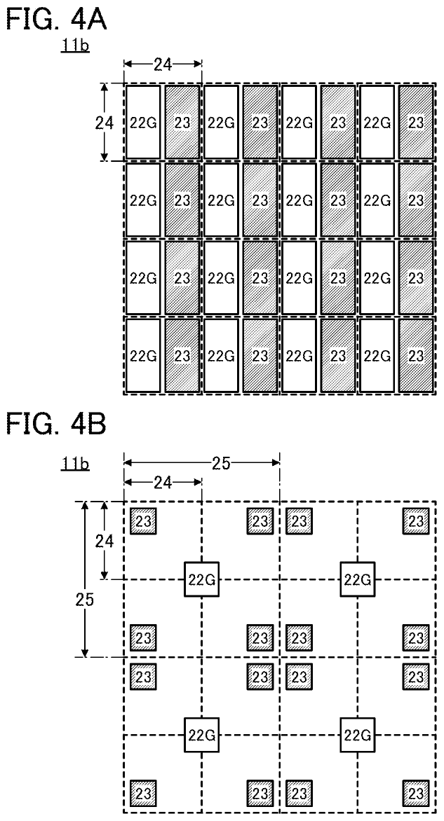

FIG. 4A illustrates a configuration of pixels that can be used for the display portion 11b. FIG. 4A illustrates 4×4 pixels 24. The pixel 24 includes one display element 22G and one photodetector 23. With such a structure, the area of the photodetector 23 can be increased and thus the sensitivity can be increased.

FIG. 4B illustrates a configuration example of pixels different from that in FIG. 4A. FIG. 4B illustrates 2×2 units 25. One unit 25 includes one display element 22G and four photodetectors 23. The display element 22G is provided at the center of the unit 25 and the photodetector 23 is provided at each of the four corners of the unit 25. Here, it can be said that one photodetector 23 and one fourth of the pixel 22G consist of one pixel 24.

In the configuration illustrated in FIG. 4B, the resolution (arrangement density) of the photodetector 23 is twice as high as that of the display element 22G. With such a configuration, an extremely high-resolution image can be captured.

In FIG. 4B, four photodetectors 23 are adjacently provided to each other and the photodetectors 23 and the display elements 22G are provided apart from each other. Such a configuration is particularly suitable for the case where organic EL elements are used for the display elements 22G and organic photodiodes are used for the photodetectors 23. For example, when a layer included in the photodetector 23 can be formed with an evaporation method, an ink-jet method, or the like, it can be formed to cover a region of the adjacent four photodetectors 23. In the case where a layer included in the display element 22G and a layer included in the photodetector 23 are formed using an evaporation method with a metal mask, an ink-jet method, or the like, the manufacturing yield can be increased as the pitches between the display elements 22G and the photodetectors 23 increase.

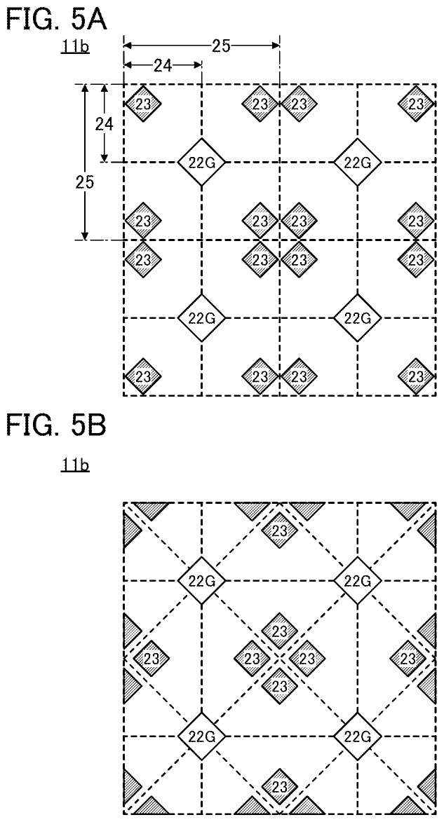

FIG. 5A and FIG. 5B illustrate configurations with which manufacturing yield is higher than that in FIG. 4B.

FIG. 5A illustrates a configuration in which the display element 22G and the photodetector 23 in the configuration of FIG. 4B are rotated by 45°. With such a structure, the pitches between the display elements 22G and the photodetectors 23 can be larger.

In the structure illustrated in FIG. 5B, the display elements 22G illustrated in FIG. 4B are rotated by 45° and the adjacent four photodetectors 23 are rotated by 45° without changing their relative positions. FIG. 5B illustrates a configuration in which eight photodetectors 23 are positioned with the same pitches to the one display element 22G. Such a structure can increase the pitches between the display elements 22G and the photodetectors 23 compared to the configurations in FIG. 4B and FIG. 5A.

### [Structure Example 2 of Electronic Device]

An example of a structure of an electronic device which is different from the above will be described below.

### Structure Example 2-1

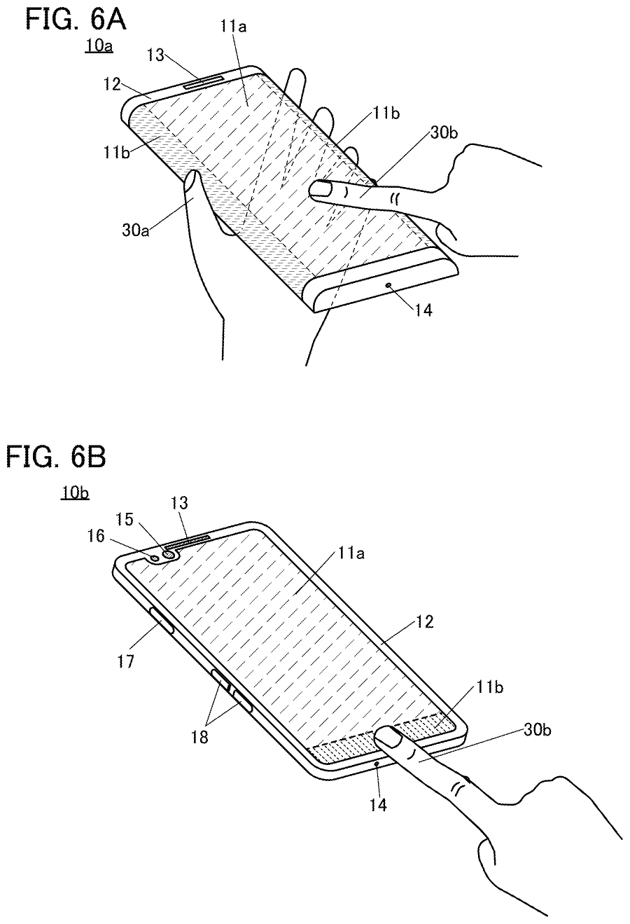

FIG. 6A illustrates a structure example of an electronic device 10a. The electronic device 10a is different from the electronic device 10 illustrated in FIG. 1A mainly in that the electronic device 10a includes a pair of display portions 11b and has a different shape of the housing 12.

The two side surfaces of the housing 12 along the longitudinal direction have curving shapes. The pair of display portions 11b is provided the along curving surfaces of the side surfaces of the housing 12. In addition, the pair of display portions 11b is symmetrically provided with the display portion 11a positioned therebetween.

With such a structure, the electronic device 10 can be held with either a right hand or a left hand.

### Structure Example 2-2

FIG. 6B illustrates a structure example of the electronic device 10b. The electronic device 10b has a structure in which a screen is provided on the upper side of the housing 12.

In addition, FIG. 6B illustrates an example in which the electronic device 10b includes a camera 15, a light source 16, a physical button 17, and a physical button 18.

The display portion 11a and the display portion 11b are provided inside the bezel of the housing 12 surrounding them. The display portion 11b is provided in contact with lower part of the inner contour of the bezel of the housing 12. The display portion 11b has a smaller area than the display portion 11a.

With such a structure, the area of the display portion 11a functioning as a main display surface can be increased, which improves visibility, browsability and convenience. When the display portion 11b which can capture an image of fingerprints is placed on the lower side of the display, an image can be displayed with no unnaturalness even when the resolution of the display elements of the display portion 11b is low.

### Structure Example 2-3

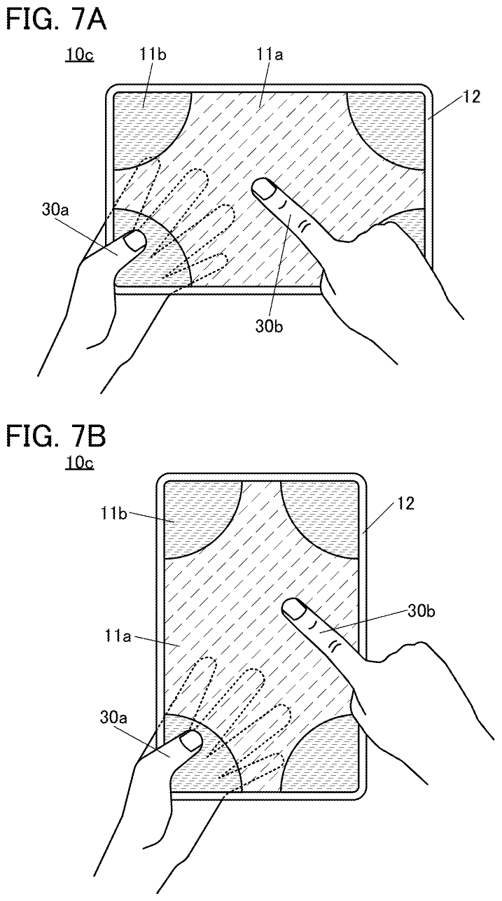

FIG. 7A and FIG. 7B illustrate structure examples of a tablet electronic device 10c.

The housing 12 included in the electronic device 10c includes a bezel surrounding the display portion 11a and the display portion 11b. The bezel has a quadrangular shape with rounded corners. In the electronic device 10c, four display portions 11b are provided along the inner contour of the bezel. The display portions 11b are provided at the corners of the inner contour of the bezel. In other words, the display portion 11b is provided in contact with two adjacent sides of the inner contour of the bezel.

FIG. 7A illustrates an example in which the electronic device 10c is used with the long side of the housing 12 substantially horizontal (also referred to as Landscape mode). FIG. 7B illustrates an example in which the electronic device 10c is used with the short side of the housing 12 substantially horizontal (also referred to as Portrait mode). In that case, an image of the fingerprint of the finger 30a can be captured when the hand (here left hand) holding the electronic device 10c is in contact with one of the four display portions 11b. As described above, the display portions 11b are arranged at the corners inside the bezel of the housing 12, whereby an image of a fingerprint can be surely captured even when the electronic device 10c is rotated regardless of which hand holds the electronic device 10c.

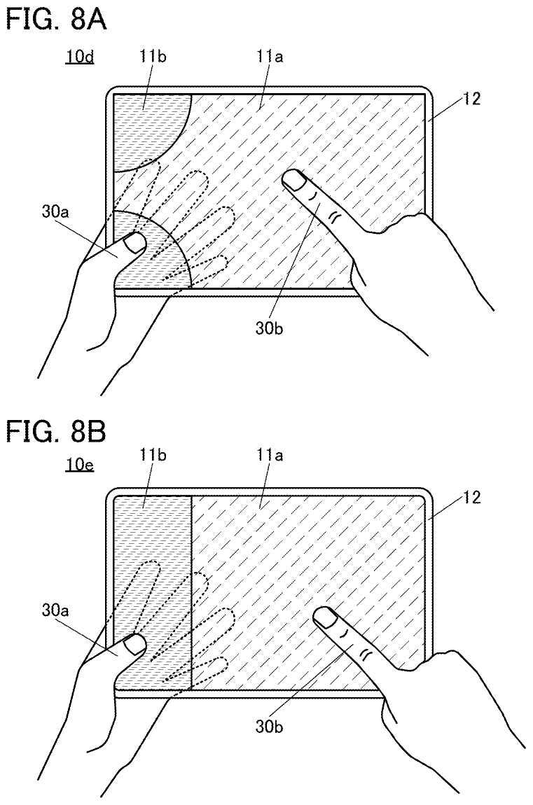

FIG. 8A illustrates a configuration example of an electronic device 10d. As illustrated in FIG. 8A, a configuration may be employed in which two display portions 11b are provided in the bezel of the housing 12. At this time, it is preferable that the display portions 11b be arranged at the two corners at the ends of one short side in the inner contour of the bezel of the housing 12. Thus, even when the electronic device 10d is used in the Landscape mode or the Portrait mode, the display portion 11b can capture an image of a fingerprint.

Note that although FIG. 8A illustrates an example where the electronic device 10d is held by a hand, the electronic device 10d is rotated by 180° when held by a right hand.

FIG. 8B illustrates a configuration example of an electronic device 10e. In the electronic device 10e, one display portion 11b is provided in a region along a short side of the inner contour of the bezel of the housing 12. With such a structure, an image of a fingerprint can be captured with the display portion 11b in both cases of the electronic device 10e used in the Landscape mode and in the Portrait mode as in the case of the electronic device 10d.

At least part of this embodiment can be implemented in combination with the other embodiments described in this specification as appropriate.

### Embodiment 2

In this embodiment, a configuration example of the display device of one embodiment of the present invention is described with reference to diagrams. Display devices illustrated below as examples can be included in the first display portion and the second display portion of the electronic device illustrated in Embodiment 1.

A display device shown below as an example includes a light-emitting element and a photodetector. The display device has a function of displaying an image, a function of performing position sensing with reflected light from an object to be sensed, and a function of capturing an image of a fingerprint or the like with reflected light from an object to be sensed. The display device shown below as an example can also be regarded to have a function of a touch panel and a function of a fingerprint sensor.

A display device according to one embodiment of the present invention includes a light-emitting element emitting first light (light-emitting device) and a photodetector receiving the first light (light-receiving device). The photodetector is preferably a photoelectric conversion element. As the first light, visible light or infrared light can be used. In the case where infrared light is used as the first light, in addition to the light-emitting element emitting the first light, a light-emitting element emitting visible light can be included.

In addition, the display device includes a pair of substrates (also referred to as first substrate and second substrate). The light-emitting element and the photodetector are arranged between the first substrate and the second substrate. The first substrate is positioned on a display surface side, and the second substrate is positioned on a side opposite to the display surface side.

Visible light is emitted from the light-emitting element to the outside through the first substrate. A plurality of such light-emitting elements arranged in a matrix are included in the display device, so that an image can be displayed.

The first light emitted from the light-emitting element reaches a surface of the first substrate. Here, when an object touches a surface of the first substrate, the first light is scattered at an interface between the first substrate and the object, and part of the scattered light enters the photodetector. When receiving the first light, the photodetector can convert the light into an electric signal in accordance with the intensity of the first light and output the electric signal. In the case where a plurality of photodetectors arranged in a matrix are included in the display device, positional data, shape, or the like of the object that touches the first substrate can be sensed. That is, the display device can function as an image sensor panel, a touch sensor panel, or the like.

Note that even in the case where the object does not touch the surface of the first substrate, the first light that has passed the first substrate is reflected or scattered in the surface of the object, and the reflected light or the scattered light is incident on the photodetector through the first substrate. Thus, the display device can also be used as a non-contact touch sensor panel (also referred to as a near-touch panel).

In the case where visible light is used as the first light, the first light used for image display can be used as a light source of a touch sensor. In that case, the light-emitting element has a function of a display element and a function of a light source, so that the structure of the display device can be simplified. In contrast, in the case where infrared light is used as the first light, a user does not perceive the infrared light, so that image capturing or sensing can be performed with the photodetector without a reduction in visibility of a displayed image.

In the case where infrared light is used as the first light, infrared light, preferably near-infrared light is used. In particular, near-infrared light having one or more peaks in the range of a wavelength greater than or equal to 700 nm and less than or equal to 2500 nm can be favorably used. In particular, the use of light having one or more peaks in the range of a wavelength greater than or equal to 750 nm and less than or equal to 1000 nm is preferable because it permits an extensive choice of a material used for an active layer of the photodetector.

When a fingertip touches a surface of the display device, the image of a shape of a fingerprint can be captured. The fingerprint has a projection and a depression. The first light is likely to be scattered in the projection of the fingerprint that touches the surface of the first substrate when a finger touches the first substrate. Therefore, the intensity of scattered light that enters the photodetector overlapping with the projection of the fingerprint is high, and the intensity of scattered light that enters the photodetector overlapping with the depression is low. Utilizing this, a fingerprint image can be captured. A device including the display device of one embodiment of the present invention can perform fingerprint authentication, which is a kind of biometric authentication, by utilizing a captured fingerprint image.

In addition, the display device can also capture an image of a blood vessel, especially a vein of a finger, a hand, or the like. For example, light having a wavelength of 760 nm and its vicinity is not absorbed by reduced hemoglobin in a vein, so that the position of the vein can be sensed by making an image from reflected light from a palm, a finger, or the like that is received with the photodetector. A device including the display device of one embodiment of the present invention can perform vein authentication, which is a kind of biometric authentication, by utilizing a captured vein image.

In addition, the device including the display device of one embodiment of the present invention can perform touch sensing, fingerprint authentication, and vein authentication at the same time. Thus, high-security biological authentication can be performed at low cost without increasing the number of components.

The photodetector is preferably an element capable of receiving visible light and infrared light. In that case, as the light-emitting element, both a light-emitting element emitting infrared light and a light-emitting element emitting visible light are preferably included. Accordingly, visible light is reflected by a user's finger and reflected light is received by the photodetector, so that an image of a fingerprint can be captured. Furthermore, an image of a shape of a vein can be captured with infrared light. Accordingly, both fingerprint authentication and vein authentication can be performed in one display device. Moreover, fingerprint image capturing and vein image capturing may be performed either at different timings or at the same time. In the case where fingerprint image capturing and vein image capturing are performed at the same time, image data including both data on the shape of a fingerprint and data on the shape of a vein can be obtained, so that biometric authentication with higher accuracy can be achieved.

The display device of one embodiment of the present invention may have a function of sensing user's health conditions. For example, by utilizing changes in reflectance and transmittance with respect to visible light and infrared light in accordance with a change in blood oxygen saturation, temporal modulation of the oxygen saturation is obtained, from which a heart rate can be measured. Furthermore, a glucose concentration in dermis, a neutral fat concentration in the blood, or the like can also be measured with infrared light or visible light. The device including the display device of one embodiment of the present invention can be used as a health care device capable of obtaining index data on user's health conditions.

As the first substrate, a sealing substrate for sealing the light-emitting element, a protective film, or the like can be used, for example. In addition, a resin layer may be provided between the first substrate and the second substrate to attach the first substrate and the second substrate to each other.

Here, as the light-emitting element, an EL element such as an OLED (Organic Light Emitting Diode) or a QLED (Quantum-dot Light Emitting Diode) is preferably used. As a light-emitting substance included in the EL element, a substance which emits fluorescence (fluorescent material), a substance which emits phosphorescence (phosphorescent material), an inorganic compound (e.g., quantum dot material), a substance which exhibits thermally activated delayed fluorescence (thermally activated delayed fluorescent (TADF) material), and the like can be given. Alternatively, an LED such as a micro-LED (Light Emitting Diode) can be used as the light-emitting element.

As the photodetector, a pn photodiode or a pin photodiode can be used, for example. The photodetector functions as a photoelectric conversion element that senses light incident on the photodetector and generates charge. The amount of generated charge in the photoelectric conversion element is determined depending on the amount of incident light. It is particularly preferable to use an organic photodiode including a layer containing an organic compound as the photodetector. An organic photodiode, which is easily made thin, lightweight, and large in area and has a high degree of freedom for shape and design, can be used in a variety of display devices.

The light-emitting element can have a stacked-layer structure including a light-emitting layer between a pair of electrodes, for example. The photodetector can have a stacked-layer structure including an active layer between a pair of electrodes. A semiconductor material can be used for the active layer of the photodetector. For example, an inorganic semiconductor material such as silicon can be used.

An organic compound is preferably used for the active layer of the photodetector. In that case, one electrode of the light-emitting element and one electrode of the photodetector (the electrodes are also referred to as pixel electrodes) are preferably provided on the same plane. It is further preferable that the other electrode of the light-emitting element and the other electrode of the photodetector be an electrode (also referred to as common electrode) formed using one continuous conductive layer. It is still further preferable that the light-emitting element and the photodetector include a common layer. Thus, the manufacturing process of the light-emitting element and the photodetector can be simplified, so that the manufacturing cost can be reduced and the manufacturing yield can be increased.

More specific examples are described below with reference to drawings.

### [Structure Example 1 of Display Device]

### Structure Example 1-1

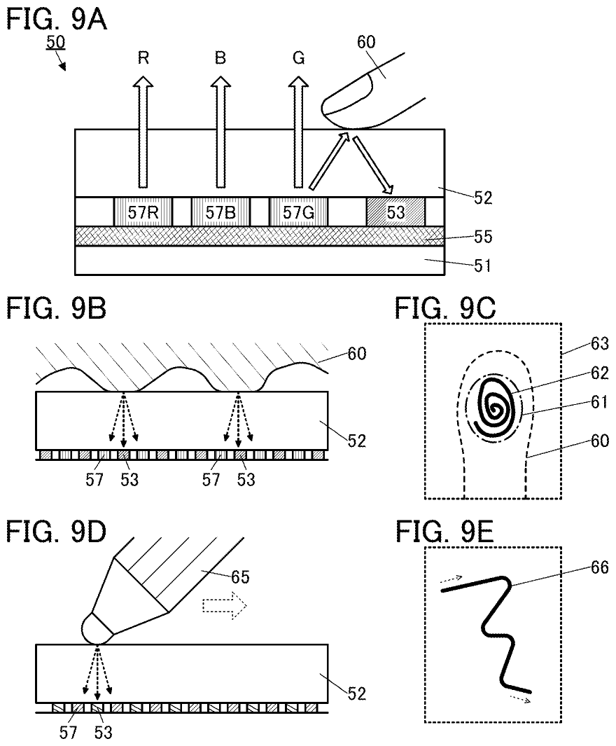

A schematic diagram of a display device 50 is illustrated in FIG. 9A. The display device 50 includes a substrate 51, a substrate 52, a photodetector 53, a light-emitting element 57R, a light-emitting element 57G, a light-emitting element 57B, a functional layer 55, and the like.

The light-emitting element 57R, the light-emitting element 57G, the light-emitting element 57B, and the photodetector 53 are provided between the substrate 51 and the substrate 52.

The light-emitting element 57R, the light-emitting element 57G, and the light-emitting element 57B emit red (R) light, green (G) light, and blue (B) light, respectively.

The display device 50 includes a plurality of pixels arranged in a matrix. One pixel includes one or more subpixels. One subpixel includes one light-emitting element. For example, the pixel can have a structure including three subpixels (e.g., three colors of R, G, and B or three colors of yellow (Y), cyan (C), and magenta (M)) or four subpixels (e.g., four colors of R, G, B, and white (W) or four colors of R, G, B, and Y). The pixel further includes the photodetector 53. The photodetector 53 may be provided in all the pixels or may be provided in some of the pixels. In addition, one pixel may include a plurality of photodetectors 53.

FIG. 9A illustrates a finger 60 touching a surface of the substrate 52. Part of light emitted from the light-emitting element 57G is reflected or scattered at a contact portion of the substrate 52 and the finger 60. In the case where part of reflected light or scattered light is incident on the photodetector 53, the contact of the finger 60 with the substrate 52 can be sensed. That is, the display device 50 can function as a touch panel.

The functional layer 55 includes a circuit that drives the light-emitting element 57R, the light-emitting element 57G, and the light-emitting element 57B and a circuit that drives the photodetector 53. The functional layer 55 is provided with a switch, a transistor, a capacitor, a wiring, and the like. Note that in the case where the light-emitting element 57R, the light-emitting element 57G, the light-emitting element 57B, and the photodetector 53 are driven by a passive-matrix method, a structure not provided with a switch or a transistor may be employed.

The display device 50 may have a function of sensing a fingerprint of the finger 60. FIG. 9B schematically illustrates an enlarged view of the contact portion in a state where the finger 60 touches the substrate 52. FIG. 9B illustrates light-emitting elements 57 and the photodetectors 53 that are alternately arranged.

The fingerprint of the finger 60 is formed of depressions and projections. Therefore, as shown in FIG. 9B, the projections of the fingerprint touch the substrate 52, and scattered light (indicated by dashed arrows) occurs at the contact surfaces.

As shown in FIG. 9B, in the intensity distribution of the scattered light on the surface where the finger 60 touches the substrate 52, the intensity of light almost perpendicular to the contact surface is the highest, and the intensity of light becomes lower as an angle becomes larger in an oblique direction. Thus, the intensity of light received by the photodetector 53 positioned directly below the contact surface (i.e., overlapping with the contact surface) is the highest. Scattered light at greater than or equal to a predetermined scattering angle is fully reflected in the other surface (a surface opposite to the contact surface) of the substrate 52 and does not pass through the photodetector 53. As a result, a clear fingerprint image can be captured.

In the case where an arrangement interval between the photodetectors 53 is smaller than a distance between two projections of a fingerprint, preferably a distance between a depression and a projection adjacent to each other, a clear fingerprint image can be obtained. The distance between a depression and a projection of a human's fingerprint is approximately 200 μm; thus, the arrangement interval between the photodetectors 53 is, for example, less than or equal to 400 μm, preferably less than or equal to 200 μm, further preferably less than or equal to 150 μm, still further preferably less than or equal to 100 μm, even still further preferably less than or equal to 50 μm and greater than or equal to 1 μm, preferably greater than or equal to 10 μm, further preferably greater than or equal to 20 μm.

FIG. 9C illustrates an example of a fingerprint image captured with the display device 50. In an image-capturing range 63 in FIG. 9C, the outline of the finger 60 is indicated with a dashed line and the outline of a contact portion 61 is indicated with a dashed-dotted line. In the contact portion 61, a high-contrast image of a fingerprint 62 can be captured owing to a difference in the amount of light incident on the photodetectors 53.

The display device 50 can also function as a touch panel or a pen tablet. FIG. 9D shows a state in which a tip of a stylus 65 slides in a direction indicated with a dashed arrow while the tip of the stylus 65 touches the substrate 52.

As shown in FIG. 9D, when light scattered at the contact surface of the tip of the stylus 65 and the substrate 52 is incident on the photodetector 53 that overlaps with the contact surface, the position of the tip of the stylus 65 can be sensed with high accuracy.

FIG. 9E illustrates an example of a path 66 of the stylus 65 that is sensed with the display device 50. The display device 50 can sense the position of a sensing target, such as the stylus 65, with high position accuracy, so that high-definition drawing can be performed using a drawing application or the like. Unlike the case of using a capacitive touch sensor, an electromagnetic induction touch pen, or the like, the display device 50 can detect even the position of a highly insulating object to be detected, the material of a tip portion of the stylus 65 is not limited, and a variety of writing materials (e.g., a brush, a glass pen, a quill pen, and the like) can be used.

### Structure Example 1-2

An example of a structure including a light-emitting element emitting visible light, a light-emitting element emitting infrared light, and a photodetector is described below.

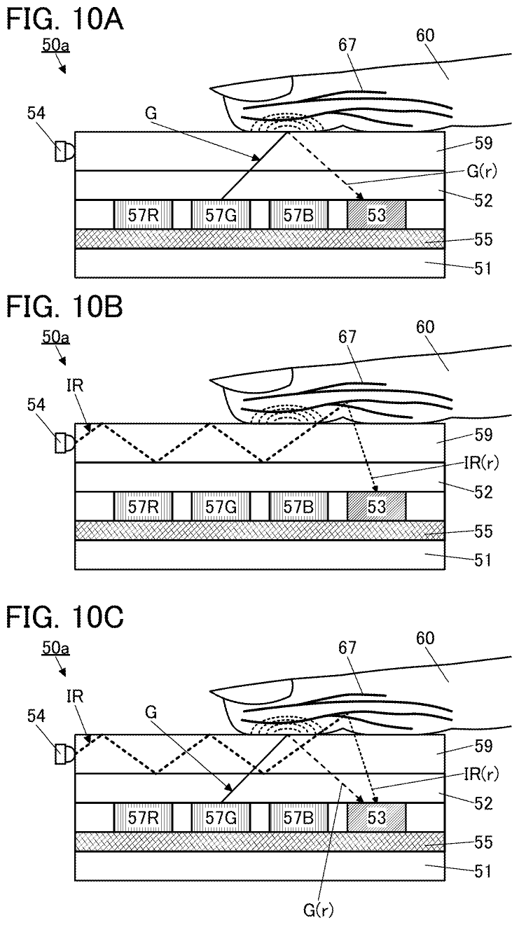

A display device 50a illustrated in FIG. 10A includes a light guide plate 59 and the light-emitting element 54 in addition to the display device 50 illustrated as an example in FIG. 9A.

The light guide plate 59 is provided over the substrate 52. As the light guide plate 59, a material having a high light-transmitting property with respect to visible light and infrared light is preferably used. For example, a material whose light-transmitting property with respect to both light having a wavelength of 600 nm and light having a wavelength of 800 nm is 80% or more, preferably 85% or more, further preferably 90% or more, still further preferably 95% or more and 100% or less can be used.

Furthermore, as the light guide plate 59, a material having a high refractive index with respect to light emitted by the light-emitting element 54 is preferably used. For example, a material whose refractive index with respect to light having a wavelength of 800 nm is higher than or equal to 1.2 and lower than or equal to 2.5, preferably higher than or equal to 1.3 and lower than or equal to 2.0, further preferably higher than or equal to 1.4 and lower than or equal to 1.8 can be used.

Moreover, it is preferable that the light guide plate 59 and the substrate 52 be provided in contact with each other or be attached to each other with a resin layer or the like. In this case, the substrate 52 or the resin layer in contact with the light guide plate 59 preferably has a lower refractive index with respect to light in a wavelength range from 800 nm to 1000 nm than the light guide plate 59, in at least a portion in contact with the light guide plate 59.

The light-emitting element 54 is provided in the vicinity of a side surface of the light guide plate 59. The light-emitting element 54 can emit infrared light IR to the side surface of the light guide plate 59. As the light-emitting element 54, a light-emitting element that can emit infrared light including light having the above-described wavelength can be used. As the light-emitting element 54, an EL element such as an OLED or a QLED or an LED can be used. A plurality of light-emitting elements 54 may be provided along the side surface of the light guide plate 59.

An example of a case where an image of a user's fingerprint and an image of a user's blood vessel are captured by using the display device 50a is described below. The display device 50a can execute a mode of performing image capturing of a fingerprint with the use of visible light, a mode of performing image capturing of a blood vessel with the use of infrared light, and a mode of performing image capturing of a fingerprint and a blood vessel as one image with the use of both visible light and infrared light.

FIG. 10A illustrates a state in which image capturing of a fingerprint is performed with the use of visible light. In this case, the light-emitting element 54 is not made to emit light, and the light-emitting element 57G is made to emit light. Green light G emitted by the light-emitting element 57G is delivered to a surface of the finger 60, and part of the light is reflected or scattered. Then, part of the scattered light G(r) enters the photodetector 53. Since the photodetectors 53 are arranged in a matrix, an image of the fingerprint of the finger 60 can be obtained by mapping the intensity of the scattered light G(r) sensed by each photodetector 53.

FIG. 10B illustrates a state in which image capturing of a blood vessel is performed with the use of infrared light. In this case, the light-emitting element 57R, the light-emitting element 57G, and the light-emitting element 57B are not made to emit light; and the light-emitting element 54 is made to emit light. Part of the infrared light IR which diffuses inside the light guide plate 59 passes through the contact portion between the light guide plate 59 and the finger 60 and reaches the inside of the finger 60. Then, part of the infrared light IR is reflected or scattered by a blood vessel 67 positioned inside the finger 60, and the scattered light IR(r) enters the photodetector 53. By mapping the intensity of the scattered light IR(r) detected with the photodetector 53 in a manner similar to that described above, an image of the blood vessel 67 can be obtained.

FIG. 10C illustrates a state in which image capturing with the use of visible light and image capturing with the use of infrared light are concurrently performed. The scattered light G(r) and the scattered light IR(r) enter the photodetector 53. By performing mapping in a manner similar to that described above without discriminating between the intensities of two kinds of scattered light obtained by the photodetector 53, an image reflecting the shape of the fingerprint and the shape of the blood vessel 67 can be obtained.

Here, the blood vessel 67 includes a vein and an artery. In the case of obtaining an image of a vein inside the finger 60, the image can be used for vein authentication.

Furthermore, the reflectance with respect to infrared light or visible light of an artery (arteriole) inside the finger 60 changes in accordance with a change in blood oxygen saturation. By obtaining this change over time, i.e., temporal modulation of a degree of blood oxygen saturation, information on the pulse wave can be obtained. Thus, the user's heart rate can be measured. Although an example in which data on the pulse wave is obtained with the infrared light IR is described here, measurement is possible with the use of visible light.

The data obtained by capturing images of the inside of the finger 60 and the blood vessel 67 can be oxygen saturation in blood, the neutral fat concentration in blood, the glucose concentration in blood or dermis, and the like. The blood sugar level can be estimated from the glucose concentration. This kind of data is an indicator of user's health conditions; changes of daily health conditions can be monitored by measuring the data once or more a day. An electronic device including the display device of one embodiment of the present invention can obtain biological data at the same time when the device executes fingerprint authentication or vein authentication; accordingly, management of user's health is unconsciously possible without troubling the user.

Note that although the light-emitting element 57G, which emits green light, is used as a light source of visible light in the above description, without limitation thereto, the light-emitting element 57R or the light-emitting element 57B may be used or two or more of the three light-emitting elements may be used. In particular, when a blue light-emitting element with low luminous efficacy function is used as a light source, a decrease in visibility of an image can be inhibited at the time of performing touch sensing or capturing an image of a fingerprint.

As the light-emitting element 54, as well as one kind of light-emitting element, a plurality of light-emitting elements that emit infrared light with different wavelengths or a light-emitting element that emits continuous-wavelength infrared light may be used. As a light source used for fingerprint authentication, vein authentication, or obtainment of biological data, a light source that emits light of a wavelength appropriate for the uses can be selected and used.

### Structure Example 1-3

A flexible material is used as the substrate included in the display device of one embodiment of the present invention, whereby the display device can be bent. With such a structure, part of the display device can be provided along a curving surface.

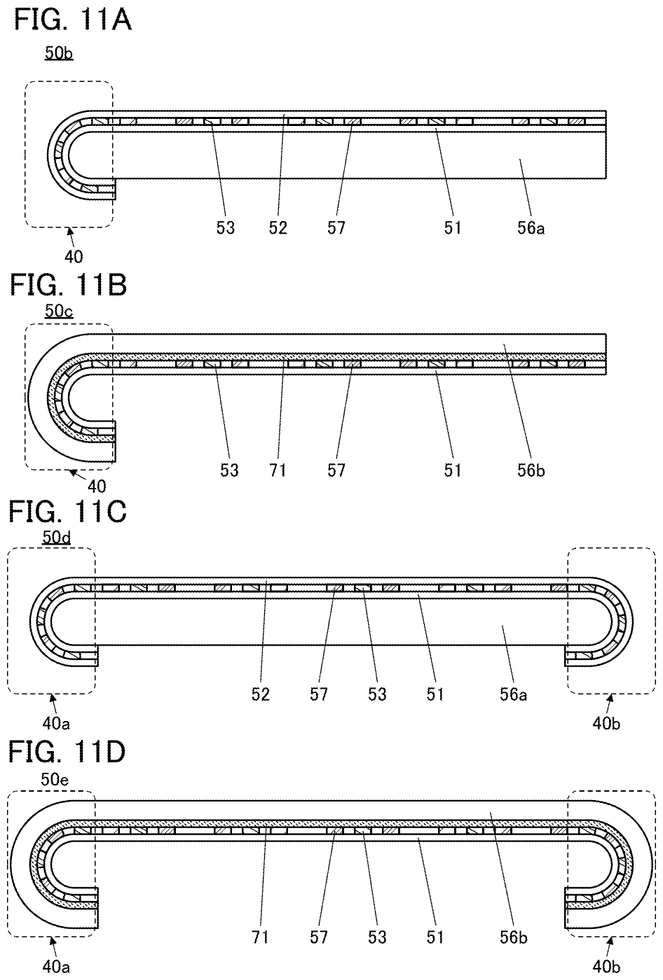

FIG. 11A illustrates a structure example of a display device 50b. In FIG. 11A, the substrate 51, the substrate 52, the photodetector 53, and the light-emitting element 57 are illustrated as the display device to avoid complexity of the diagram.

The display device 50b includes a curving portion 40. In the curving portion 40, an end portion of the display device 50b is bent by 180°.

FIG. 11A illustrates an example in which the substrate 51 is supported by a support body 56a. As the support body 56a, part of a housing of an electronic device into which the display device 50b is incorporated can be used. The substrate 51 is supported with the support body 56a, which can increase the mechanical strength. It is favorable to support the substrate 51 with the support body 56a especially when a flexible substrate is used as the substrate 51.

For the substrate 51 and the substrate 52, a flexible material can be used. For example, a material including an organic resin or the like is preferably used for the substrate 51 and the substrate 52. An inorganic insulating substrate such as a glass substrate which is thin enough to have flexibility is preferably used as the substrate 51 and the substrate 52.

A portion other than the curving portion 40 of the display device 50b can be referred to as a first display portion functioning as a main display surface. Furthermore, the curving portion 40 can be referred to as a second display portion functioning as a sub display surface.

Here, the light-emitting elements 53 provided in the curving portion 40 (i.e., second display portion) are preferably provided at a density higher than that in the first display portion. The area of the second display portion is preferably smaller than that of the first display portion.

In the curving portion 40, the light-emitting elements 57 can display an image along the curving surface. Furthermore, the photodetector 53 provided in the curving portion 40 can receive light reflected by a sensing target touching the curving portion 40 or the like.

Although an example in which the display device 50b is curving by 180 degrees at the curving portion 40 is illustrated in FIG. 11A, there is no limitation thereto. For example, structures in which that is curving at an angle of greater than or equal to 30 degrees and less than or equal to 180 degrees, preferably greater than or equal to 60 degrees and less than or equal to 180 degrees, further preferably greater than or equal to 90 degrees and less than or equal to 180 degrees can be used.

A display device 50c illustrated in FIG. 11B is different from the above-described display device 50b in that the display device 50c is supported with a support body 56b positioned on the display surface side.

The support body 56b functions as a protective member that protects the display surface of the display device 50c. The support body 56b preferably has a light-transmitting property to visible light or to visible light and infrared light since the support body 56b is positioned on the display surface side of the display device 50c. The support body 56b may also have a function of a touch sensor. The support body 56b may have a function of a polarizing plate (including linear polarizing plate, circularly polarizing plate, and the like), a scattering plate, a diffusing plate, an anti-reflection member, or the like.

The display device 50c includes an adhesive layer 71 instead of the substrate 52. The substrate 51 and the support body 56b are bonded to each other with the adhesive layer 71. As the adhesive layer 71, an organic resin transmitting visible light or visible light and infrared light can be favorably used.

A display device 50d illustrated in FIG. 11C includes a pair of curving portions 40a and 40b. The display device 50d includes a pair of curving portions each positioned in the second display portion, between which a portion positioned in the first display portion is sandwiched.

With this structure, both end portions of the display device 50d can be folded back toward the side opposite to the main display surface side, whereby the bezel in an electronic device including the display device 50d can be substantially eliminated. Thus, an electronic device with excellent design and convenience can be achieved.

A display device 50d includes the support body 56a on the opposing side to the display surface side. A structure in which the support body 56b is provided on the display surface side as in a display device 50e illustrated in FIG. 11D may be employed. The display device 50e is attached to the support body 56b with the adhesive layer 71.

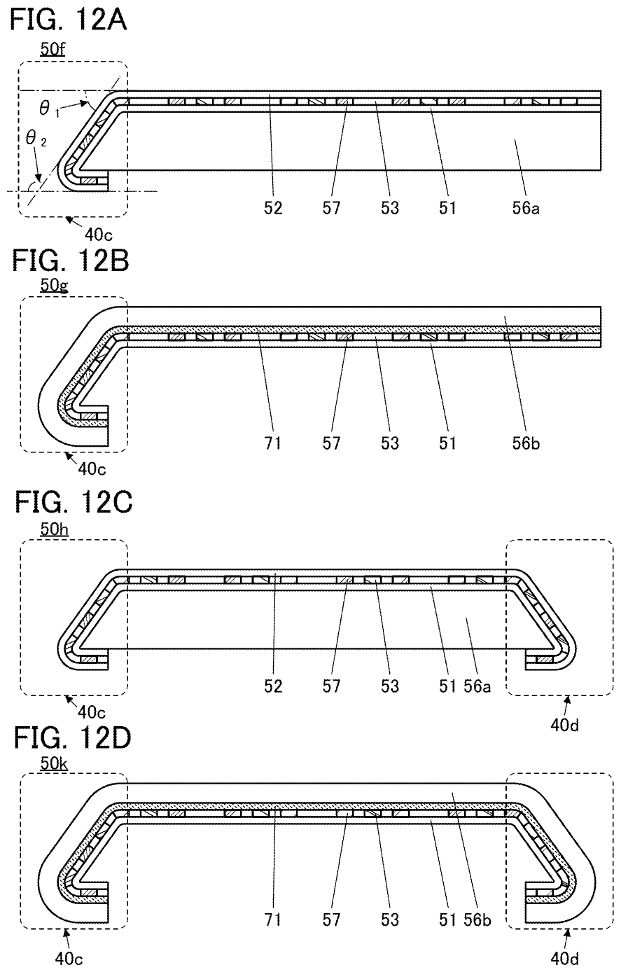

A display device 50f illustrated in FIG. 12A is an example in which a curving portion 40c functioning as the second display portion has a flat surface. The display device 50f includes a portion positioned in the first display portion and a portion positioned in the curving portion 40c functioning as the second display portion. A flat portion of the display device 50f positioned in the curving portion 40c is provided so as to be sandwiched between a pair of curving portions. In other words, in the display device 50f, a curving portion is provided between the portion positioned in the first display portion and the flat portion positioned in the curving portion 40c.

It can also be said that a display device 50f illustrated in FIG. 12A includes the first display portion functioning as the main display surface and the second display portion that is tilted away from the first display portion. It can be said that the first display portion and the second display portion have different normal directions. With the structure in which part of the curving portion 40c has the flat portion, the contact area of the curving portion 40c and a finger that touches the curving portion 40c can be increased, enabling recognition with higher accuracy.

Here, an angle (angle θ₁) formed between a surface positioned in the first display portion of the display device 50f and a surface of the flat portion positioned in the curving portion 40c of the display device 50f is preferably greater than 0 degrees and less than or equal to 90 degrees. Specifically, the angle can be greater than or equal to 15 degrees and less than or equal to 90 degrees, preferably greater than or equal to 20 degrees and less than 90 degrees, further preferably greater than or equal to 25 degrees and less than or equal to 90 degrees. The angle θ₁ can be typically 30 degrees, 45 degrees, 60 degrees, 75 degrees, or the like.

Furthermore, an angle (angle θ₂) formed between the surface of the flat portion positioned in the curving portion 40c of the display device 50f and a surface of a flat portion in the vicinity of the end portion is preferably an angle obtained by subtracting the above-described angle θ₁ from 180 degrees.

Here, the area of the second display portion is preferably smaller than that of the first display portion.

Although FIG. 12A illustrates an example in which the support body 56a is provided on the side opposite to the display surface side of the display device 50f, a structure in which the support body 56b is provided on the display surface side may be employed as in a display device 50g illustrated in FIG. 12B. The display device 50g is attached to the support body 56b with the adhesive layer 71.

Alternatively, as in a display device 50h illustrated in FIG. 12C and a display device 50k illustrated in FIG. 12D, a pair of a curving portion 40c and a curving portion 40d may be included. With such a structure, both end portions of the display device 50h or the display device 50k can be folded back toward the side opposite to the main display surface, whereby the bezel in an electronic device including the display device 50h or the display device 50k can be substantially eliminated. Thus, an electronic device with excellent design and convenience can be obtained.

The above is the description of the Structure example 1 of the display device.

### [Structure Example 2 of Display Device]

### Structure Example 2-1

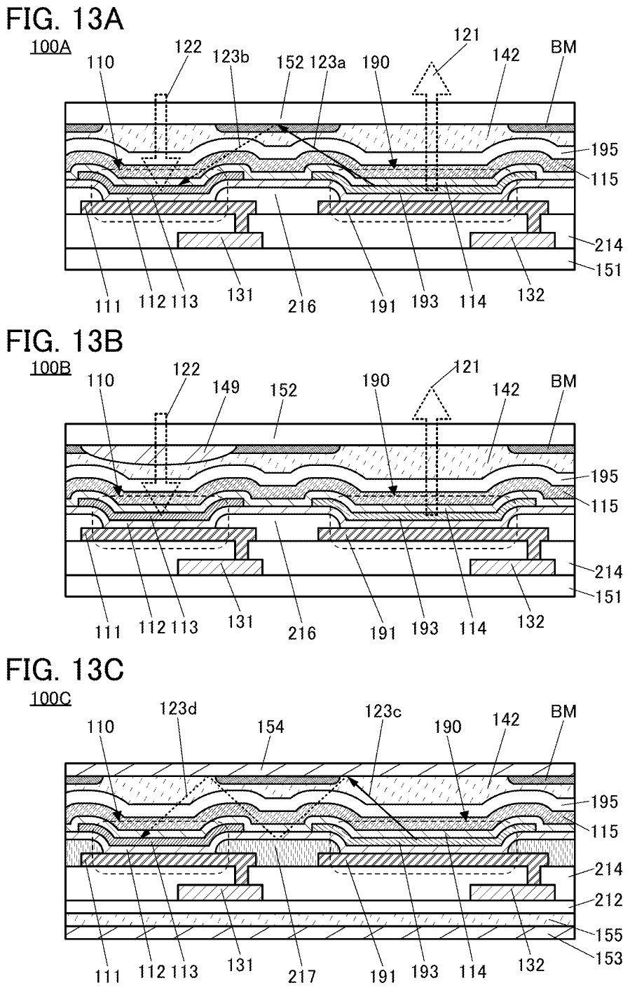

FIG. 13A illustrates a schematic cross-sectional view of a display device 100A.

The display device 100A includes a photodetector 110 and a light-emitting element 190. The photodetector 110 includes a pixel electrode 111, a common layer 112, an active layer 113, a common layer 114, and a common electrode 115. The light-emitting element 190 includes a pixel electrode 191, the common layer 112, a light-emitting layer 193, the common layer 114, and the common electrode 115.

The pixel electrode 111, the pixel electrode 191, the common layer 112, the active layer 113, the light-emitting layer 193, the common layer 114, and the common electrode 115 may each have a single-layer structure or a stacked-layer structure.

The pixel electrode 111 and the pixel electrode 191 are positioned over an insulating layer 214. The pixel electrode 111 and the pixel electrode 191 can be formed using the same material in the same step.

The common layer 112 is positioned over the pixel electrode 111 and the pixel electrode 191. The common layer 112 is a layer shared by the photodetector 110 and the light-emitting element 190.

The active layer 113 overlaps with the pixel electrode 111 with the common layer 112 therebetween. The light-emitting layer 193 overlaps with the pixel electrode 191 with the common layer 112 therebetween. The active layer 113 includes a first organic compound, and the light-emitting layer 193 includes a second organic compound that is different from the first organic compound.

The common layer 114 is positioned over the common layer 112, the active layer 113, and the light-emitting layer 193. The common layer 114 is a layer shared by the photodetector 110 and the light-emitting element 190.

The common electrode 115 includes a portion overlapping with the pixel electrode 111 with the common layer 112, the active layer 113, and the common layer 114 therebetween. The common electrode 115 further includes a portion overlapping with the pixel electrode 191 with the common layer 112, the light-emitting layer 193, and the common layer 114 therebetween. The common electrode 115 is a layer shared by the photodetector 110 and the light-emitting element 190.

In the display device of this embodiment, an organic compound is used for the active layer 113 of the photodetector 110. In the photodetector 110, the layers other than the active layer 113 can have structures in common with the layers in the light-emitting element 190 (EL element). Therefore, the photodetector 110 can be formed concurrently with the formation of the light-emitting element 190 only by adding a step of depositing the active layer 113 in the manufacturing process of the light-emitting element 190. The light-emitting element 190 and the photodetector 110 can be formed over one substrate. Accordingly, the photodetector 110 can be incorporated into the display device without a significant increase in the number of manufacturing steps.

The display device 100A illustrates an example in which the photodetector 110 and the light-emitting element 190 have a common structure except that the active layer 113 of the photodetector 110 and the light-emitting layer 193 of the light-emitting element 190 are separately formed. Note that the structures of the photodetector 110 and the light-emitting element 190 are not limited thereto. The photodetector 110 and the light-emitting element 190 may include separately formed layers other than the active layer 113 and the light-emitting layer 193 (see display devices 100D, 100E, and 100F described later). The photodetector 110 and the light-emitting element 190 preferably include at least one layer used in common (common layer). Thus, the photodetector 110 can be incorporated into the display device without a significant increase in the number of manufacturing steps.

The display device 100A includes the photodetector 110, the light-emitting element 190, a transistor 131, a transistor 132, and the like between a pair of substrates (substrate 151 and substrate 152).

In the photodetector 110, the common layer 112, the active layer 113, and the common layer 114, which are positioned between the pixel electrode 111 and the common electrode 115, can each also be referred to as an organic layer (a layer including an organic compound). The pixel electrode 111 preferably has a function of reflecting visible light. An end portion of the pixel electrode 111 is covered with a bank 216. The common electrode 115 has a function of transmitting visible light.

The photodetector 110 has a function of sensing light. Specifically, the photodetector 110 is a photoelectric conversion element that receives light 122 entering from the outside through the substrate 152 and converts the light 122 into an electrical signal.

A light-blocking layer BM is provided on a surface of the substrate 152 that faces the substrate 151. The light-blocking layer BM has an opening in a position overlapping with the photodetector 110 and in a position overlapping with the light-emitting element 190. Providing the light-blocking layer BM can control the range where the photodetector 110 senses light.

For the light-blocking layer BM, a material that blocks light emitted from the light-emitting element can be used. The light-blocking layer BM preferably absorbs visible light. As the light-blocking layer BM, a black matrix can be formed using a metal material or a resin material containing pigment (e.g., carbon black) or dye, for example. The light-blocking layer BM may have a stacked-layer structure of a red color filter, a green color filter, and a blue color filter.

Here, part of light emitted from the light-emitting element 190 is reflected in the display device 100A and is incident on the photodetector 110 in some cases. The light-blocking layer BM can reduce the influence of such stray light. For example, in the case where the light-blocking layer BM is not provided, light 123a emitted from the light-emitting element 190 is reflected by the substrate 152 and reflected light 123b enters the photodetector 110 in some cases. Providing the light-blocking layer BM can inhibit the reflected light 123b from entering the photodetector 110. Consequently, noise can be reduced, and the sensitivity of a sensor using the photodetector 110 can be increased.

In the light-emitting element 190, the common layer 112, the light-emitting layer 193, and the common layer 114, which are positioned between the pixel electrode 191 and the common electrode 115, can each also be referred to as an EL layer. The pixel electrode 191 preferably has a function of reflecting visible light. An end portion of the pixel electrode 191 is covered with the bank 216. The pixel electrode 111 and the pixel electrode 191 are electrically insulated from each other by the bank 216. The common electrode 115 has a function of transmitting visible light.

The light-emitting element 190 has a function of emitting visible light. Specifically, the light-emitting element 190 is an electroluminescent element that emits light 121 to the substrate 152 side when voltage is applied between the pixel electrode 191 and the common electrode 115.

It is preferable that the light-emitting layer 193 be formed not to overlap with a light-receiving region of the photodetector 110. This inhibits the light-emitting layer 193 from absorbing the light 122, increasing the amount of light with which the photodetector 110 is irradiated.

The pixel electrode 111 is electrically connected to a source or a drain of the transistor 131 through an opening provided in the insulating layer 214. The end portion of the pixel electrode 111 is covered with the bank 216.

The pixel electrode 191 is electrically connected to a source or a drain of the transistor 132 through an opening provided in the insulating layer 214. The end portion of the pixel electrode 191 is covered with the bank 216. The transistor 132 has a function of controlling the driving of the light-emitting element 190.

The transistor 131 and the transistor 132 are in contact with the same layer (substrate 151 in FIG. 13A).

At least part of a circuit electrically connected to the photodetector 110 and a circuit electrically connected to the light-emitting element 190 are preferably formed using the same material in the same step. In that case, the thickness of the display device can be reduced compared with the case where the two circuits are separately formed, resulting in simplification of the manufacturing steps.

Here, it is preferable that the common electrode 115 shared by the light-emitting element 190 and the photodetector 110 be electrically connected to a wiring to which a first potential is supplied. As the first potential, a fixed potential such as a common potential, a ground potential, or a reference potential can be used. Note that the first potential supplied to the common electrode 115 is not limited to a fixed potential, and two or more different potentials can be selected to be supplied.

When the photodetector 110 receives light and converts the light into an electric signal, the pixel electrode 111 is preferably supplied with a second potential lower than the first potential supplied to the common electrode 115. As the second potential, a potential with which light-reception sensitivity or the like is optimized can be selected to be supplied in accordance with the structure, the optical characteristics, the electrical characteristics, or the like of the photodetector 110. That is, in the case where the photodetector 110 is regarded as a photodiode, the first potential supplied to the common electrode 115 functioning as a cathode and the second potential supplied to the pixel electrode 191 functioning as an anode can be selected so that reverse bias voltage is applied. When the photodetector 110 is not driven, a potential at the same or substantially the same level as the first potential or a potential higher than the first potential may be supplied to the pixel electrode 111.

In contrast, when the light-emitting element 190 is made to emit light, the pixel electrode 191 is preferably supplied with a third potential higher than the first potential supplied to the common electrode 115. As the third potential, a potential with which required emission luminance is achieved can be selected to be supplied in accordance with the structure, the threshold voltage, the current-luminance characteristics, or the like of the light-emitting element 190. That is, in the case where the light-emitting element 190 is regarded as a light-emitting diode, the first potential supplied to the common electrode 115 functioning as a cathode and the third potential supplied to the pixel electrode 191 functioning as an anode can be selected so that forward bias voltage is applied. When the light-emitting element 190 is not made to emit light, a potential at the same or substantially the same level as the first potential or a potential lower than the first potential may be supplied to the pixel electrode 191.

Here, the case where the common electrode 115 functions as a cathode and the pixel electrodes each function as an anode in the photodetector 110 and the light-emitting element 190 is described as an example, but one embodiment of the present invention is not limited thereto; the common electrode 115 may function as an anode and the pixel electrodes may each function as a cathode. In such a case, a potential higher than the first potential is supplied as the second potential to drive the photodetector 110, and a potential lower than the first potential is supplied as the third potential to drive the light-emitting element 190.

The photodetector 110 and the light-emitting element 190 are preferably covered with a protective layer 195. In FIG. 13A, the protective layer 195 is provided over and in contact with the common electrode 115. Providing the protective layer 195 can inhibit entry of impurities such as water into the photodetector 110 and the light-emitting element 190, so that the reliability of the photodetector 110 and the light-emitting element 190 can be increased. The protective layer 195 and the substrate 152 are bonded to each other with an adhesive layer 142.

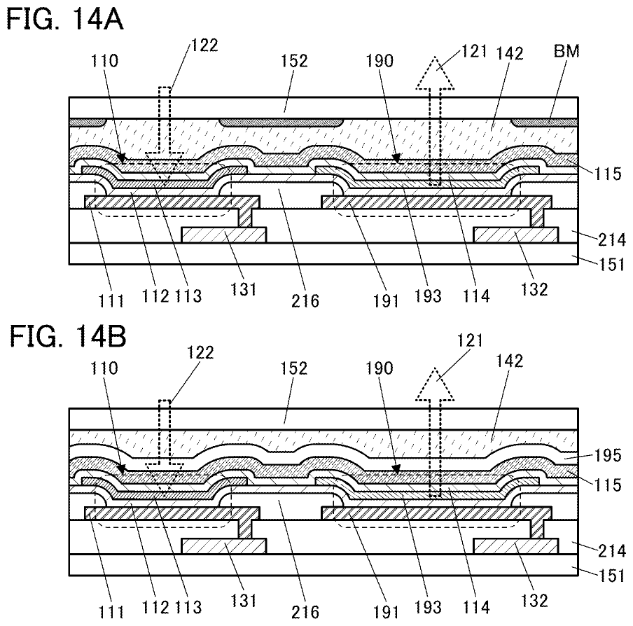

Note that as illustrated in FIG. 14A, the protective layer over the photodetector 110 and the light-emitting element 190 may be omitted. In FIG. 14A, the common electrode 115 and the substrate 152 are bonded to each other with the adhesive layer 142.

A structure that does not include the light-blocking layer BM as illustrated in FIG. 14B may be employed. This can increase the light-receiving area of the photodetector 110, further increasing the sensitivity of the sensor.

### Structure Example 2-2

FIG. 13B shows cross-sectional views of a display device 100B. Note that in the description of the display device below, components similar to those of the above-mentioned display device are not described in some cases.

The display device 100B illustrated in FIG. 13B includes a lens 149 in addition to the components of the display device 100A.

The lens 149 is provided in a position overlapping with the photodetector 110. In the display device 100B, the lens 149 is provided in contact with the substrate 152. The lens 149 included in the display device 100B is a convex lens having a convex surface on the substrate 151 side. Note that a convex lens having a convex surface on the substrate 152 side may be provided in a region overlapping with the photodetector 110.

In the case where the light-blocking layer BM and the lens 149 are formed on the same plane of the substrate 152, their formation order is not limited. FIG. 13B illustrates an example in which the lens 149 is formed first; alternatively, the light-blocking layer BM may be formed first. In FIG. 13B, an end portion of the lens 149 is covered with the light-blocking layer BM.

The display device 100B has a structure in which the light 122 enters the photodetector 110 through the lens 149. With the lens 149, the amount of the light 122 incident on the photodetector 110 can be increased compared to the case where the lens 149 is not provided. This can increase the sensitivity of the photodetector 110.

As a method for forming the lens used in the display device of this embodiment, a lens such as a microlens may be formed directly over the substrate or the photodetector, or a lens array formed separately, such as a microlens array, may be bonded to the substrate.

### Structure Example 2-3

FIG. 13C illustrates a schematic cross-sectional view of a display device 100C. The display device 100C is different from the display device 100A in that the substrate 151, the substrate 152, and the bank 216 are not included but a substrate 153, a substrate 154, an adhesive layer 155, an insulating layer 212, and a partition wall 217 are included.

The substrate 153 and the insulating layer 212 are bonded to each other with the adhesive layer 155. The substrate 154 and the protective layer 195 are bonded to each other with the adhesive layer 142.

The display device 100C has a structure obtained in such a manner that the insulating layer 212, the transistor 131, the transistor 132, the photodetector 110, the light-emitting element 190, and the like are formed over a formation substrate and then transferred onto the substrate 153. The substrate 153 and the substrate 154 preferably have flexibility. Accordingly, the display device 100C can be highly flexible. For example, a resin is preferably used for each of the substrate 153 and the substrate 154.

For each of the substrate 153 and the substrate 154, a polyester resin such as polyethylene terephthalate (PET) or polyethylene naphthalate (PEN), a polyacrylonitrile resin, an acrylic resin, a polyimide resin, a polymethyl methacrylate resin, a polycarbonate (PC) resin, a polyether sulfone (PES) resin, a polyamide resin (e.g., nylon or aramid), a polysiloxane resin, a cycloolefin resin, a polystyrene resin, a polyamide-imide resin, a polyurethane resin, a polyvinyl chloride resin, a polyvinylidene chloride resin, a polypropylene resin, a polytetrafluoroethylene (PTFE) resin, an ABS resin, or cellulose nanofiber can be used, for example. Glass that is thin enough to have flexibility may be used for one or both of the substrate 153 and the substrate 154.

As the substrate included in the display device of this embodiment, a film having high optical isotropy may be used. Examples of the film having high optical isotropy include a triacetyl cellulose (TAC, also referred to as cellulose triacetate) film, a cycloolefin polymer (COP) film, a cycloolefin copolymer (COC) film, and an acrylic film.

The partition wall 217 preferably absorbs light emitted by the light-emitting element. As the partition wall 217, a black matrix can be formed using a resin material containing a pigment or dye, for example. Moreover, the partition wall 217 can be formed of a colored insulating layer by using a brown resist material.

Light 123c emitted from the light-emitting element 190 might be reflected by the substrate 152 and the partition wall 217 and reflected light 123d might be incident on the photodetector 110. In other cases, the light 123c passes through the partition wall 217 and is reflected by a transistor, a wiring, or the like, and thus reflected light enters the photodetector 110. When the partition wall 217 absorbs the light 123c, the reflected light 123d can be inhibited from entering the photodetector 110. Consequently, noise can be reduced, and the sensitivity of a sensor using the photodetector 110 can be increased.

The partition wall 217 preferably absorbs at least light having a wavelength that is sensed by the photodetector 110. For example, in the case where the photodetector 110 senses red light emitted by the light-emitting element 190, the partition wall 217 preferably absorbs at least red light. For example, when the partition wall 217 includes a blue color filter, the partition wall 217 can absorb the red light 123c and thus the reflected light 123d can be inhibited from entering the photodetector 110.

### Structure Example 2-4

Although the light-emitting element and the photodetector include two common layers in the above examples, one embodiment of the present invention is not limited thereto. Examples in which common layers have different structures are described below.

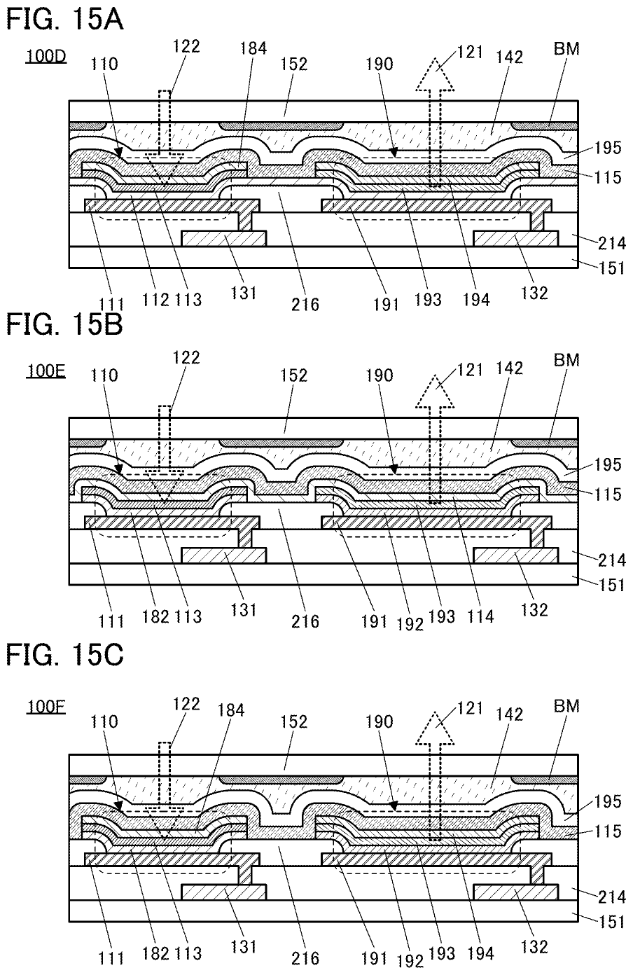

FIG. 15A is a schematic cross-sectional view of a display device 100D. The display device 100D is different from the display device 100A in that the common layer 114 is not included and a buffer layer 184 and a buffer layer 194 are included. The buffer layer 184 and the buffer layer 194 may each have a single-layer structure or a stacked-layer structure.

In the display device 100D, the photodetector 110 includes the pixel electrode 111, the common layer 112, the active layer 113, the buffer layer 184, and the common electrode 115. In the display device 100D, the light-emitting element 190 includes the pixel electrode 191, the common layer 112, the light-emitting layer 193, the buffer layer 194, and the common electrode 115.

The display device 100D shows an example in which the buffer layer 184 between the common electrode 115 and the active layer 113 and the buffer layer 194 between the common electrode 115 and the light-emitting layer 193 are formed separately. As the buffer layer 184 and the buffer layer 194, one or both of an electron-injection layer and an electron-transport layer can be formed, for example.

FIG. 15B illustrates a schematic cross-sectional view of a display device 100E. The display device 100E is different from the display device 100A in that the common layer 112 is not included and a buffer layer 182 and a buffer layer 192 are included. The buffer layer 182 and the buffer layer 192 may each have a single-layer structure or a stacked-layer structure.

In the display device 100E, the photodetector 110 includes the pixel electrode 111, the buffer layer 182, the active layer 113, the common layer 114, and the common electrode 115. In the display device 100E, the light-emitting element 190 includes the pixel electrode 191, the buffer layer 192, the light-emitting layer 193, the common layer 114, and the common electrode 115.

The display device 100E shows an example in which the buffer layer 182 between the pixel electrode 111 and the active layer 113 and the buffer layer 192 between the pixel electrode 191 and the light-emitting layer 193 are formed separately. As the buffer layer 182 and the buffer layer 192, one or both of a hole-injection layer and a hole-transport layer can be formed, for example.

FIG. 15C illustrates a schematic cross-sectional view of a display device 100F. The display device 100F is different from the display device 100A in that the common layer 112 and the common layer 114 are not included and the buffer layer 182, the buffer layer 184, the buffer layer 192, and the buffer layer 194 are included.

In the display device 100F, the photodetector 110 includes the pixel electrode 111, the buffer layer 182, the active layer 113, the buffer layer 184, and the common electrode 115. In the display device 100F, the light-emitting element 190 includes the pixel electrode 191, the buffer layer 192, the light-emitting layer 193, the buffer layer 194, and the common electrode 115.

In the formation of the photodetector 110 and the light-emitting element 190, not only the active layer 113 and the light-emitting layer 193 but also other layers can be formed separately.

The display device 100F shows an example in which the photodetector 110 and the light-emitting element 190 do not have a common layer between the pair of electrodes (the pixel electrode 111 or the pixel electrode 191 and the common electrode 115). The photodetector 110 and the light-emitting element 190 included in the display device 100F can be formed in the following manner: the pixel electrode 111 and the pixel electrode 191 are formed over the insulating layer 214 using the same material in the same step; the buffer layer 182, the active layer 113, and the buffer layer 184 are formed over the pixel electrode 111, and the buffer layer 192, the light-emitting layer 193, and the buffer layer 194 are formed over the pixel electrode 191; and then, the common electrode 115 is formed to cover the buffer layer 184, the buffer layer 194, and the like.

Note that the formation order of the stacked-layer structure of the buffer layer 182, the active layer 113, and the buffer layer 184 and the stacked-layer structure of the buffer layer 192, the light-emitting layer 193, and the buffer layer 194 is not particularly limited. For example, after the buffer layer 182, the active layer 113, and the buffer layer 184 are deposited, the buffer layer 192, the light-emitting layer 193, and the buffer layer 194 may be deposited. In contrast, the buffer layer 192, the light-emitting layer 193, and the buffer layer 194 may be deposited before the buffer layer 182, the active layer 113, and the buffer layer 184 are deposited. Alternate deposition of the buffer layer 182, the buffer layer 192, the active layer 113, the light-emitting layer 193, and the like in this order is also possible.

### [Structure Example 3 of Display Device]

More specific examples of a cross-sectional structure of the display device are described below.

### Structure Example 3-1

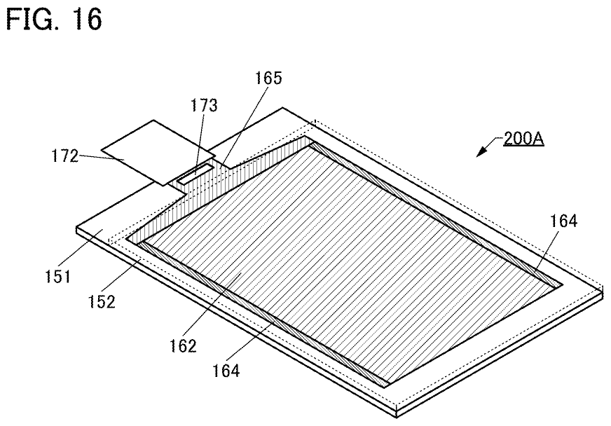

FIG. 16 illustrates a perspective view of a display device 200A.

The display device 200A has a structure in which the substrate 151 and the substrate 152 are bonded to each other. In FIG. 16, the substrate 152 is denoted with a dashed line.

The display device 200A includes a display portion 162, a circuit 164, a wiring 165, and the like. FIG. 16 illustrates an example in which the display device 200A is provided with an IC (integrated circuit) 173 and an FPC 172. Thus, the configuration illustrated in FIG. 16 can be regarded as a display module including the display device 200A, the IC, and the FPC.

As the circuit 164, a scan line driver circuit can be used.

The wiring 165 has a function of supplying a signal and power to the display portion 162 and the circuit 164. The signal and power are input to the wiring 165 from the outside through the FPC 172 or from the IC 173.

FIG. 16 illustrates an example in which the IC 173 is provided over the substrate 151 by a COG (Chip On Glass) method, a COF (Chip On Film) method, or the like. An IC including a scan line driver circuit, a signal line driver circuit, or the like can be used as the IC 173, for example. Note that the display device 200A and the display module may have a structure not including an IC. The IC may be mounted on the FPC with a COF method or the like.

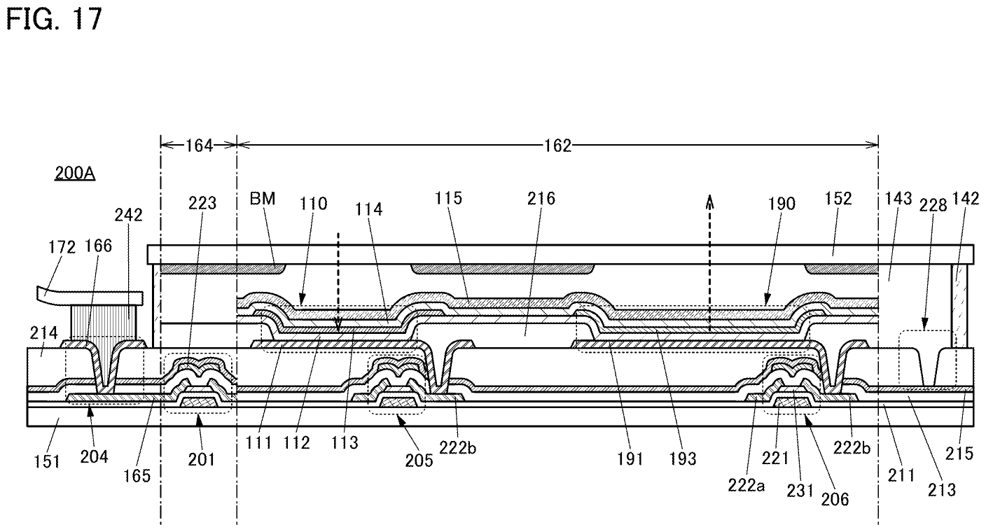

FIG. 17 illustrates an example of a cross section of part of a region including the FPC 172, part of a region including the circuit 164, part of a region including the display portion 162, and part of a region including an end portion of the display device 200A illustrated in FIG. 16.

The display device 200A illustrated in FIG. 17 includes a transistor 201, a transistor 205, a transistor 206, the light-emitting element 190, the photodetector 110, and the like between the substrate 151 and the substrate 152.

The substrate 152 and the insulating layer 214 are attached to each other with the adhesive layer 142. A solid sealing structure, a hollow sealing structure, or the like can be employed to seal the light-emitting element 190 and the photodetector 110. In FIG. 17, a hollow sealing structure is employed in which a space 143 surrounded by the substrate 152, the adhesive layer 142, and the insulating layer 214 is filled with an inert gas (e.g., nitrogen or argon). The adhesive layer 142 may be provided to overlap with the light-emitting element 190. The space 143 surrounded with the substrate 152, the adhesive layer 142, and the insulating layer 214 may be filled with a resin different from that of the adhesive layer 142.

The light-emitting element 190 has a stacked-layer structure in which the pixel electrode 191, the common layer 112, the light-emitting layer 193, the common layer 114, and the common electrode 115 are stacked in this order from the insulating layer 214 side. The pixel electrode 191 is connected to a conductive layer 222b included in the transistor 206 through an opening provided in the insulating layer 214. The transistor 206 has a function of controlling the driving of the light-emitting element 190. The end portion of the pixel electrode 191 is covered with the bank 216. The pixel electrode 191 includes a material that reflects visible light, and the common electrode 115 includes a material that transmits visible light.

The photodetector 110 has a stacked-layer structure in which the pixel electrode 111, the common layer 112, the active layer 113, the common layer 114, and the common electrode 115 are stacked in this order from the insulating layer 214 side. The pixel electrode 111 is electrically connected to the conductive layer 222b included in the transistor 205 through an opening provided in the insulating layer 214. The end portion of the pixel electrode 111 is covered with the bank 216. The pixel electrode 111 includes a material that reflects visible light, and the common electrode 115 includes a material that transmits visible light.

Light emitted from the light-emitting element 190 is emitted toward the substrate 152 side. Light enters the photodetector 110 through the substrate 152 and the space 143. For the substrate 152, a material that has high transmittance with respect to visible light is preferably used.

The pixel electrode 111 and the pixel electrode 191 can be formed using the same material in the same step. The common layer 112, the common layer 114, and the common electrode 115 are used in both the photodetector 110 and the light-emitting element 190. The photodetector 110 and the light-emitting element 190 can have common components except the active layer 113 and the light-emitting layer 193. Thus, the photodetector 110 can be incorporated into the display device 100A without a significant increase in the number of manufacturing steps.

A light-blocking layer BM is provided on a surface of the substrate 152 that faces the substrate 151. The light-blocking layer BM has an opening in a position overlapping with the photodetector 110 and in a position overlapping with the light-emitting element 190. Providing the light-blocking layer BM can control the range where the photodetector 110 senses light. Furthermore, with the light-blocking layer BM, light from the light-emitting element 190 can be inhibited from directly entering the photodetector 110. Hence, a sensor with less noise and high sensitivity can be obtained.

The transistor 201, the transistor 205, and the transistor 206 are formed over the substrate 151. These transistors can be formed using the same materials in the same steps.

An insulating layer 211, an insulating layer 213, an insulating layer 215, and the insulating layer 214 are provided in this order over the substrate 151. Parts of the insulating layer 211 function as gate insulating layers of the transistors. Parts of the insulating layer 213 function as gate insulating layers of the transistors. The insulating layer 215 is provided to cover the transistors. The insulating layer 214 is provided to cover the transistors and has a function of a planarization layer. Note that there is no limitation on the number of gate insulating layers and the number of insulating layers covering the transistors, and each insulating layer may have either a single layer or two or more layers.

A material into which impurities such as water and hydrogen do not easily diffuse is preferably used for at least one of the insulating layers that cover the transistors. This allows the insulating layer to serve as a barrier layer. Such a structure can effectively inhibit diffusion of impurities into the transistors from the outside and increase the reliability of the display device.

An inorganic insulating film is preferably used as each of the insulating layer 211, the insulating layer 213, and the insulating layer 215. As the inorganic insulating film, for example, a silicon nitride film, a silicon oxynitride film, a silicon oxide film, a silicon nitride oxide film, an aluminum oxide film, an aluminum nitride film, or the like which is an inorganic insulating film can be used. A hafnium oxide film, an yttrium oxide film, a zirconium oxide film, a gallium oxide film, a tantalum oxide film, a magnesium oxide film, a lanthanum oxide film, a cerium oxide film, a neodymium oxide film, or the like may also be used. A stack including two or more of the above insulating films may also be used.

Here, an organic insulating film often has a lower barrier property than an inorganic insulating film. Therefore, the organic insulating film preferably has an opening in the vicinity of an end portion of the display device 200A. This can inhibit diffusion of impurities from the end portion of the display device 200A through the organic insulating film. Alternatively, in order to prevent the organic insulating film from being exposed at the end portion of the display device 200A, the organic insulating film may be formed so that its end portion is positioned on the inner side than the end portion of the display device 200A.

An organic insulating film is suitable for the insulating layer 214 functioning as a planarization layer. Examples of materials that can be used for the organic insulating film include an acrylic resin, a polyimide resin, an epoxy resin, a polyamide resin, a polyimide-amide resin, a siloxane resin, a benzocyclobutene-based resin, a phenol resin, and precursors of these resins.

In a region 228 illustrated in FIG. 17, an opening is formed in the insulating layer 214. This can inhibit diffusion of impurities into the display portion 162 from the outside through the insulating layer 214 even when an organic insulating film is used as the insulating layer 214. Thus, the reliability of the display device 200A can be increased.

Each of the transistor 201, the transistor 205, and the transistor 206 includes a conductive layer 221 functioning as a gate, the insulating layer 211 functioning as the gate insulating layer, a conductive layer 222a and the conductive layer 222b functioning as a source and a drain, a semiconductor layer 231, the insulating layer 213 functioning as the gate insulating layer, and a conductive layer 223 functioning as a gate. Here, a plurality of layers obtained by processing the same conductive film are shown with the same hatching pattern. The insulating layer 211 is positioned between the conductive layer 221 and the semiconductor layer 231. The insulating layer 213 is positioned between the conductive layer 223 and the semiconductor layer 231.

There is no particular limitation on the structure of the transistors included in the display device of this embodiment. For example, a planar transistor, a staggered transistor, or an inverted staggered transistor can be used. A top-gate or a bottom-gate transistor structure may be employed. Alternatively, gates may be provided above and below a semiconductor layer in which a channel is formed.

The structure in which the semiconductor layer where a channel is formed is provided between two gates is used for the transistor 201, the transistor 205, and the transistor 206. The two gates may be connected to each other and supplied with the same signal to drive the transistor. Alternatively, a potential for controlling the threshold voltage may be supplied to one of the two gates and a potential for driving may be supplied to the other to control the threshold voltage of the transistor.

There is no particular limitation on the crystallinity of a semiconductor material used for the transistors, and any of an amorphous semiconductor, a single crystal semiconductor, and a semiconductor having crystallinity other than single crystal (a microcrystalline semiconductor, a polycrystalline semiconductor, or a semiconductor partly including crystal regions) may be used. A single crystal semiconductor or a semiconductor having crystallinity is preferably used, in which case deterioration of the transistor characteristics can be inhibited.

A semiconductor layer of a transistor preferably includes a metal oxide (also referred to as an oxide semiconductor). Alternatively, the semiconductor layer of the transistor may include silicon. Examples of silicon include amorphous silicon and crystalline silicon (e.g., low-temperature polysilicon or single crystal silicon).

The semiconductor layer preferably includes indium, M (M is one or more kinds selected from gallium, aluminum, silicon, boron, yttrium, tin, copper, vanadium, beryllium, titanium, iron, nickel, germanium, zirconium, molybdenum, lanthanum, cerium, neodymium, hafnium, tantalum, tungsten, and magnesium), and zinc, for example. In particular, M is preferably one or more kinds selected from aluminum, gallium, yttrium, and tin.

It is particularly preferable to use an oxide containing indium (In), gallium (Ga), and zinc (Zn) (also referred to as IGZO) for the semiconductor layer.

In the case where the semiconductor layer is an In-M-Zn oxide, a sputtering target used for depositing the In-M-Zn oxide preferably has the atomic proportion of In higher than or equal to the atomic proportion of M. Examples of the atomic ratio of the metal elements in such a sputtering target include In:M:Zn=1:1:1, In:M:Zn=1:1:1.2, In:M:Zn=2:1:3, In:M:Zn=3:1:2, In:M:Zn=4:2:3, In:M:Zn=4:2:4.1, In:M:Zn=5:1:3, In:M:Zn=5:1:6, In: M:Zn=5:1:7, In:M:Zn=5:1:8, In:M:Zn=6:1:6, and In:M:Zn=5:2:5.

A target including a polycrystalline oxide is preferably used as the sputtering target, in which case the semiconductor layer having crystallinity is easily formed. Note that the atomic ratio in the deposited semiconductor layer may vary from the above atomic ratio between metal elements in the sputtering target in a range of ±40%. For example, in the case where the composition of a sputtering target used for the semiconductor layer is In:Ga:Zn=4:2:4.1 [atomic ratio], the composition of the semiconductor layer to be deposited is sometimes in the neighborhood of In:Ga:Zn=4:2:3 [atomic ratio].

Note that when the atomic ratio is described as In:Ga:Zn=4:2:3 or in the neighborhood thereof, the case is included where Ga is greater than or equal to 1 and less than or equal to 3 and Zn is greater than or equal to 2 and less than or equal to 4 with In being 4. When the atomic ratio is described as In:Ga:Zn=5:1:6 or in the neighborhood thereof, the case is included where Ga is greater than 0.1 and less than or equal to 2 and Zn is greater than or equal to 5 and less than or equal to 7 with In being 5. When the atomic ratio is described as In:Ga:Zn=1:1:1 or in the neighborhood thereof, the case is included where Ga is greater than 0.1 and less than or equal to 2 and Zn is greater than 0.1 and less than or equal to 2 with In being 1.

The transistor included in the circuit 164 and the transistor included in the display portion 162 may have the same structure or different structures. A plurality of transistors included in the circuit 164 may have the same structure or two or more kinds of structures. Similarly, a plurality of transistors included in the display portion 162 may have the same structure or two or more kinds of structures.

A connection portion 204 is provided in a region of the substrate 151 that does not overlap with the substrate 152. In the connection portion 204, the wiring 165 is electrically connected to the FPC 172 via a conductive layer 166 and a connection layer 242. On the top surface of the connection portion 204, the conductive layer 166 obtained by processing the same conductive film as the pixel electrode 191 is exposed. Thus, the connection portion 204 and the FPC 172 can be electrically connected to each other through the connection layer 242.

A variety of optical members can be arranged on the outer surface of the substrate 152. Examples of the optical members include a polarizing plate, a retardation plate, a light diffusion layer (diffusion film or the like), an anti-reflective layer, and a light-condensing film. Furthermore, an antistatic film inhibiting the attachment of dust, a water repellent film inhibiting the attachment of stain, a hard coat film inhibiting generation of a scratch caused by the use, a shock absorbing layer, or the like may be provided on the outside of the substrate 152.

For each of the substrate 151 and the substrate 152, glass, quartz, ceramic, sapphire, resin, or the like can be used. When a flexible material is used for the substrate 151 and the substrate 152, the flexibility of the display device can be increased.

As the adhesive layer, a variety of curable adhesives, e.g., a photocurable adhesive such as an ultraviolet curable adhesive, a reactive curable adhesive, a thermosetting adhesive, and an anaerobic adhesive can be used. Examples of these adhesives include an epoxy resin, an acrylic resin, a silicone resin, a phenol resin, a polyimide resin, an imide resin, a PVC (polyvinyl chloride) resin, a PVB (polyvinyl butyral) resin, and an EVA (ethylene vinyl acetate) resin. In particular, a material with low moisture permeability, such as an epoxy resin, is preferred. Alternatively, a two-component resin may be used. An adhesive sheet or the like may be used.

As the connection layer 242, an anisotropic conductive film (ACF), an anisotropic conductive paste (ACP), or the like can be used.

The light-emitting element 190 may be of a top emission type, a bottom emission type, a dual emission type, or the like. A conductive film that transmits visible light is used as the electrode through which light is extracted. A conductive film that reflects visible light is preferably used as the electrode through which light is not extracted.

The light-emitting element 190 includes at least the light-emitting layer 193. The light-emitting element 190 may further include, as a layer other than the light-emitting layer 193, a layer containing a substance with a high hole-injection property, a substance with a high hole-transport property, a hole-blocking material, a substance with a high electron-transport property, a substance with a high electron-injection property, a substance with a bipolar property (substance with high electron- and hole-transport property), or the like. For example, the common layer 112 preferably includes one or both of a hole-injection layer and a hole-transport layer. For example, the common layer 114 preferably includes one or both of an electron-transport layer and an electron-injection layer.

The common layer 112, the light-emitting layer 193, and the common layer 114 may use either a low molecular compound or a high molecular compound and may also contain an inorganic compound. The layers that constitute the common layer 112, the light-emitting layer 193, and the common layer 114 can each be formed with a method such as an evaporation method (including a vacuum evaporation method), a transfer method, a printing method, an inkjet method, or a coating method.

The light-emitting layer 193 may contain an inorganic compound such as quantum dots as a light-emitting material.

The active layer 113 of the photodetector 110 includes a semiconductor. Examples of the semiconductor include an inorganic semiconductor such as silicon and an organic semiconductor including an organic compound. This embodiment shows an example in which an organic semiconductor is used as the semiconductor included in the active layer. The use of an organic semiconductor is preferable because the light-emitting layer 193 of the light-emitting element 190 and the active layer 113 of the photodetector 110 can be formed with the same method (e.g., vacuum evaporation method) and thus the same manufacturing apparatus can be used.

Examples of an n-type semiconductor material included in the active layer 113 are electron-accepting organic semiconductor materials such as fullerene (e.g., C₆₀ and C₇₀) and derivatives thereof. As a p-type semiconductor material included in the active layer 113, an electron-donating organic semiconductor material such as copper(II) phthalocyanine (CuPc), tetraphenyldibenzoperiflanthene (DBP), or zinc phthalocyanine (ZnPc) can be given.

For example, the active layer 113 is preferably formed with co-evaporation of an n-type semiconductor and a p-type semiconductor.

As materials that can be used for a gate, a source, and a drain of a transistor and conductive layers such as a variety of wirings and electrodes included in a display device, metals such as aluminum, titanium, chromium, nickel, copper, yttrium, zirconium, molybdenum, silver, tantalum, or tungsten, an alloy containing any of these metals as its main component, and the like can be given. A film containing any of these materials can be used in a single layer or as a stacked-layer structure.

As a light-transmitting conductive material, a conductive oxide such as indium oxide, indium tin oxide, indium zinc oxide, zinc oxide, or zinc oxide containing gallium, or graphene can be used. Alternatively, a metal material such as gold, silver, platinum, magnesium, nickel, tungsten, chromium, molybdenum, iron, cobalt, copper, palladium, or titanium, or an alloy material containing the metal material can be used. Further alternatively, a nitride of the metal material (e.g., titanium nitride) or the like may be used. Note that in the case of using the metal material or the alloy material (or the nitride thereof), the thickness is preferably set small enough to be able to transmit light. A stacked-layer film of any of the above materials can be used as a conductive layer. For example, a stacked-layer film of indium tin oxide and an alloy of silver and magnesium, or the like is preferably used for increased conductivity. These materials can also be used for conductive layers such as a variety of wirings and electrodes that constitute a display device, and conductive layers (conductive layers functioning as a pixel electrode or a common electrode) included in a display element.

As an insulating material that can be used for each insulating layer, for example, a resin such as an acrylic resin or an epoxy resin, and an inorganic insulating material such as silicon oxide, silicon oxynitride, silicon nitride oxide, silicon nitride, or aluminum oxide can be given.

### Structure Example 3-2

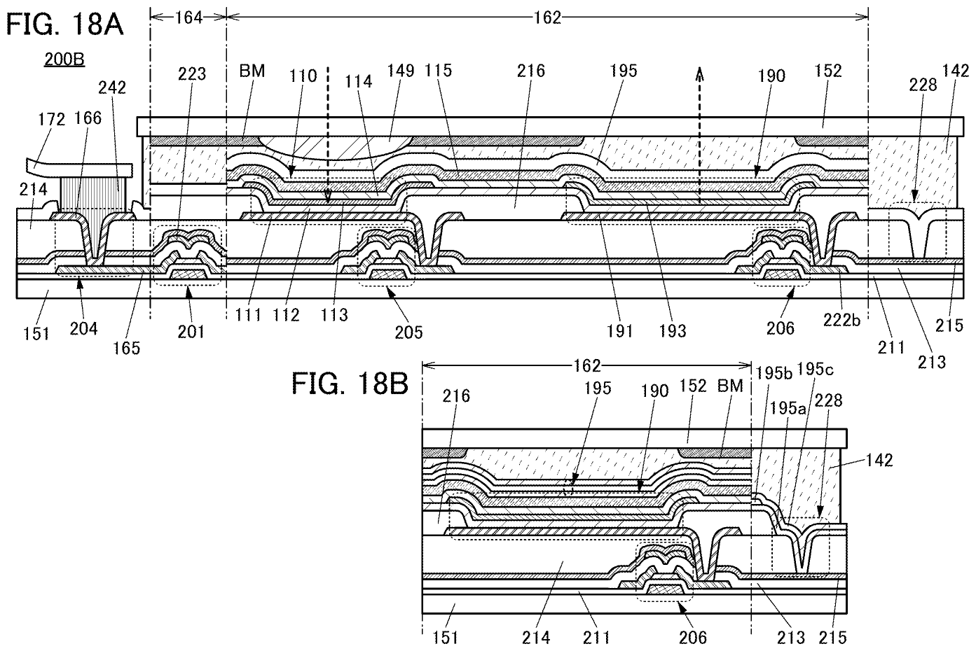

FIG. 18A shows a cross-sectional view of a display device 200B. The display device 200B is different from the display device 200A mainly in that the lens 149 and the protective layer 195 are included.

Providing the protective layer 195 covering the photodetector 110 and the light-emitting element 190 can inhibit diffusion of impurities such as water into the photodetector 110 and the light-emitting element 190, so that the reliability of the photodetector 110 and the light-emitting element 190 can be increased.

In the region 228 in the vicinity of an end portion of the display device 200B, the insulating layer 215 and the protective layer 195 are preferably in contact with each other through an opening in the insulating layer 214. In particular, the inorganic insulating film included in the insulating layer 215 and the inorganic insulating film included in the protective layer 195 are preferably in contact with each other. Thus, diffusion of impurities from the outside into the display portion 162 through the organic insulating film can be inhibited. Thus, the reliability of the display device 200B can be increased.

FIG. 18B illustrates an example in which the protective layer 195 has a three-layer structure. In FIG. 18B, the protective layer 195 includes an inorganic insulating layer 195a over the common electrode 115, an organic insulating layer 195b over the inorganic insulating layer 195a, and an inorganic insulating layer 195c over the organic insulating layer 195b.

An end portion of the inorganic insulating layer 195a and an end portion of the inorganic insulating layer 195c extend beyond an end portion of the organic insulating layer 195b and are in contact with each other. The inorganic insulating layer 195a is in contact with the insulating layer 215 (inorganic insulating layer) through the opening in the insulating layer 214 (organic insulating layer). Accordingly, the photodetector 110 and the light-emitting element 190 can be surrounded with the insulating layer 215 and the protective layer 195, whereby the reliability of the photodetector 110 and the light-emitting element 190 can be increased.

As described above, the protective layer 195 may have a stacked-layer structure of an organic insulating film and an inorganic insulating film. In that case, an end portion of the inorganic insulating film preferably extends beyond an end portion of the organic insulating film.

The lens 149 is provided on the surface of the substrate 152 that faces the substrate 151. The lens 149 has a convex surface on the substrate 151 side. It is preferable that the light-receiving region of the photodetector 110 overlap with the lens 149 and not overlap with the light-emitting layer 193. Thus, the sensitivity and accuracy of a sensor using the photodetector 110 can be increased.

The refractive index of the lens 149 with respect to light received by the photodetector 110 is preferably greater than or equal to 1.3 and less than or equal to 2.5. The lens 149 can be formed using at least one of an inorganic material and an organic material. For example, a material containing a resin can be used for the lens 149. Moreover, a material containing at least one of an oxide and a sulfide can be used for the lens 149.

Specifically, a resin containing chlorine, bromine, or iodine, a resin containing a heavy metal atom, a resin having an aromatic ring, a resin containing sulfur, or the like can be used for the lens 149. Alternatively, a material containing a resin and nanoparticles of a material having a higher refractive index than the resin can be used for the lens 149. Titanium oxide, zirconium oxide, or the like can be used for the nanoparticles.

In addition, cerium oxide, hafnium oxide, lanthanum oxide, magnesium oxide, niobium oxide, tantalum oxide, titanium oxide, yttrium oxide, zinc oxide, an oxide containing indium and tin, an oxide containing indium, gallium, and zinc, and the like can be used for the lens 149. Alternatively, zinc sulfide or the like can be used for the lens 149.

In the display device 200B, the protective layer 195 and the substrate 152 are bonded to each other with the adhesive layer 142. The adhesive layer 142 is provided to overlap with the photodetector 110 and the light-emitting element 190; that is, the display device 200B employs a solid sealing structure.

### Structure Example 3-3

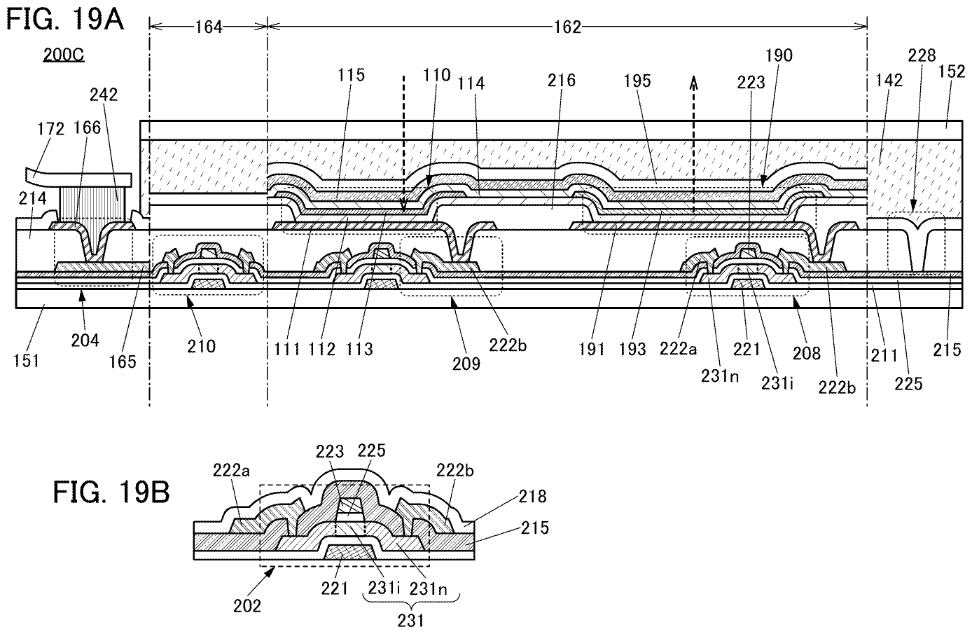

FIG. 19A shows a cross-sectional view of a display device 200C. The display device 200C is different from the display device 200B mainly in the structure of the transistors and including neither the light-blocking layer BM nor the lens 149.

The display device 200C includes a transistor 208, a transistor 209, and a transistor 210 over the substrate 151.

Each of the transistor 208, the transistor 209, and the transistor 210 includes the conductive layer 221 functioning as a gate, the insulating layer 211 functioning as a gate insulating layer, a semiconductor layer including a channel formation region 231i and a pair of low-resistance regions 231n, the conductive layer 222a connected to one of the pair of low-resistance regions 231n, the conductive layer 222b connected to the other of the pair of low-resistance regions 231n, an insulating layer 225 functioning as a gate insulating layer, the conductive layer 223 functioning as a gate, and the insulating layer 215 covering the conductive layer 223. The insulating layer 211 is positioned between the conductive layer 221 and the channel formation region 231i. The insulating layer 225 is positioned between the conductive layer 223 and the channel formation region 231i.

The conductive layer 222a and the conductive layer 222b are connected to the corresponding low-resistance regions 231n through openings provided in the insulating layer 225 and the insulating layer 215. One of the conductive layer 222a and the conductive layer 222b serves as a source, and the other serves as a drain.

The pixel electrode 191 of the light-emitting element 190 is electrically connected to one of the pair of low-resistance regions 231n of the transistor 208 through the conductive layer 222b.

The pixel electrode 111 of the photodetector 110 is electrically connected to the other of the pair of low-resistance regions 231n of the transistor 209 through the conductive layer 222b.

FIG. 19A illustrates an example in which the insulating layer 225 covers a top surface and a side surface of the semiconductor layer. Meanwhile, FIG. 19B illustrates an example in which the insulating layer 225 overlaps with the channel formation region 231i of the semiconductor layer 231 and does not overlap with the low-resistance regions 231n. The structure shown in FIG. 19B can be manufactured by processing the insulating layer 225 using the conductive layer 223 as a mask, for example. In FIG. 19B, the insulating layer 215 is provided to cover the insulating layer 225 and the conductive layer 223, and the conductive layer 222a and the conductive layer 222b are connected to the low-resistance regions 231n through the openings in the insulating layer 215. Furthermore, an insulating layer 218 covering the transistor may be provided.

### Structure Example 3-4

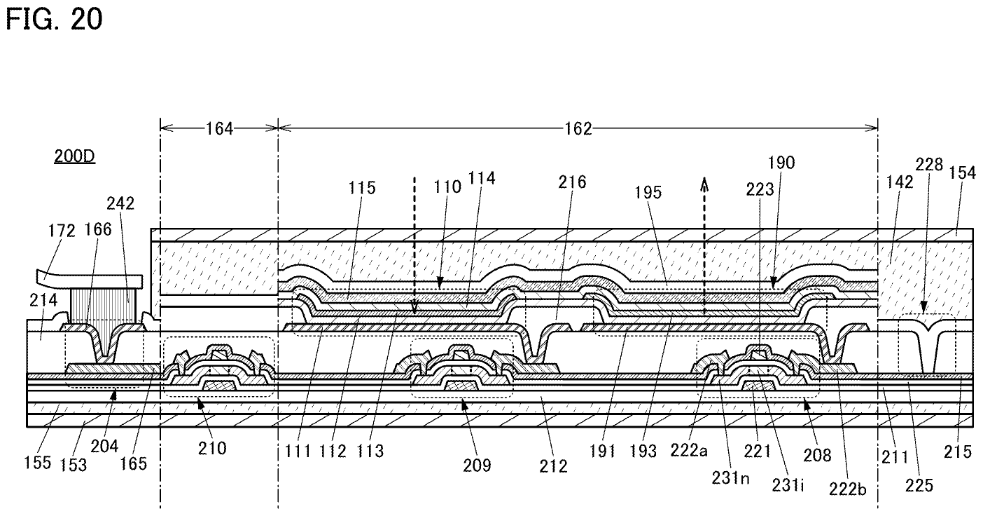

FIG. 20 shows a cross section of a display device 200D. The display device 200D is different from the display device 200C mainly in the structure of the substrates.

The display device 200D does not include the substrate 151 and the substrate 152 and includes the substrate 153, the substrate 154, the adhesive layer 155, and the insulating layer 212.

The substrate 153 and the insulating layer 212 are bonded to each other with the adhesive layer 155. The substrate 154 and the protective layer 195 are bonded to each other with the adhesive layer 142.

The display device 200D has a structure obtained in such a manner that the insulating layer 212, the transistor 208, the transistor 209, the photodetector 110, the light-emitting element 190, and the like are formed over a formation substrate and then transferred onto the substrate 153. The substrate 153 and the substrate 154 preferably have flexibility. Accordingly, the flexibility of the display device 200D can be increased.

The inorganic insulating film that can be used as the insulating layer 211, the insulating layer 213, and the insulating layer 215 can be used as the insulating layer 212. Alternatively, a stacked-layer film of an organic insulating film and an inorganic insulating film may be used as the insulating layer 212. In that case, a film on the transistor 209 side is preferably an inorganic insulating film.

The above is the description of the structure examples of the display device.

### [Metal Oxide]

A metal oxide that can be used for the semiconductor layer is described below.

Note that in this specification and the like, a metal oxide containing nitrogen is also collectively referred to as a metal oxide in some cases. A metal oxide containing nitrogen may be referred to as a metal oxynitride. For example, a metal oxide containing nitrogen, such as zinc oxynitride (ZnON), may be used for the semiconductor layer.

Note that in this specification and the like, CAAC (c-axis aligned crystal) or CAC (Cloud-Aligned Composite) may be stated. CAAC refers to an example of a crystal structure, and CAC refers to an example of a function or a material composition.

For example, a CAC (Cloud-Aligned Composite)-OS (Oxide Semiconductor) can be used for the semiconductor layer.

A CAC-OS or a CAC-metal oxide has a conducting function in part of the material and has an insulating function in another part of the material; as a whole, the CAC-OS or the CAC-metal oxide has a function of a semiconductor. In the case where the CAC-OS or the CAC-metal oxide is used in a semiconductor layer of a transistor, the conducting function is to allow electrons (or holes) serving as carriers to flow, and the insulating function is to not allow electrons serving as carriers to flow. By the complementary action of the conducting function and the insulating function, a switching function (On/Off function) can be given to the CAC-OS or the CAC-metal oxide. In the CAC-OS or the CAC-metal oxide, separation of the functions can maximize each function.

Furthermore, the CAC-OS or the CAC-metal oxide includes conductive regions and insulating regions. The conductive regions have the above-described conducting function, and the insulating regions have the above-described insulating function. Furthermore, in some cases, the conductive regions and the insulating regions in the material are separated at the nanoparticle level. Furthermore, in some cases, the conductive regions and the insulating regions are unevenly distributed in the material. Furthermore, in some cases, the conductive regions are observed to be coupled in a cloud-like manner with their boundaries blurred.

Furthermore, in the CAC-OS or the CAC-metal oxide, the conductive regions and the insulating regions each have a size greater than or equal to 0.5 nm and less than or equal to 10 nm, preferably greater than or equal to 0.5 nm and less than or equal to 3 nm, and are dispersed in the material, in some cases.

Furthermore, the CAC-OS or the CAC-metal oxide includes components having different bandgaps. For example, the CAC-OS or the CAC-metal oxide includes a component having a wide gap due to the insulating region and a component having a narrow gap due to the conductive region. In the case of the structure, when carriers flow, carriers mainly flow in the component having a narrow gap. Furthermore, the component having a narrow gap complements the component having a wide gap, and carriers also flow in the component having a wide gap in conjunction with the component having a narrow gap. Therefore, in the case where the above-described CAC-OS or CAC-metal oxide is used in a channel formation region of a transistor, high current driving capability in an on state of the transistor, that is, a high on-state current and high field-effect mobility can be obtained.

In other words, the CAC-OS or the CAC-metal oxide can also be referred to as a matrix composite or a metal matrix composite.

Oxide semiconductors (metal oxides) are classified into a single crystal oxide semiconductor and a non-single-crystal oxide semiconductor. Examples of a non-single-crystal oxide semiconductor include a CAAC-OS (c-axis aligned crystalline oxide semiconductor), a polycrystalline oxide semiconductor, an nc-OS (nanocrystalline oxide semiconductor), an amorphous-like oxide semiconductor (a-like OS), and an amorphous oxide semiconductor.

The CAAC-OS has c-axis alignment, a plurality of nanocrystals are connected in the a-b plane direction, and its crystal structure has distortion. Note that the distortion refers to a portion where the direction of a lattice arrangement changes between a region with a regular lattice arrangement and another region with a regular lattice arrangement in a region where the plurality of nanocrystals are connected.

The nanocrystal is basically a hexagon but is not always a regular hexagon and is a non-regular hexagon in some cases. Furthermore, a pentagonal or heptagonal lattice arrangement, for example, is included in the distortion in some cases. Note that it is difficult to observe a clear crystal grain boundary (also referred to as grain boundary) even in the vicinity of distortion in the CAAC-OS. That is, formation of a crystal grain boundary is found to be inhibited due to the distortion of a lattice arrangement. This is because the CAAC-OS can tolerate distortion owing to a low density of arrangement of oxygen atoms in the a-b plane direction, an interatomic bond length changed by substitution of a metal element, and the like.

The CAAC-OS tends to have a layered crystal structure (also referred to as a layered structure) in which a layer containing indium and oxygen (hereinafter, In layer) and a layer containing the element M, zinc, and oxygen (hereinafter, (M,Zn) layer) are stacked. Note that indium and the element M can be replaced with each other, and when the element M in the (M,Zn) layer is replaced with indium, the layer can also be referred to as an (In,M,Zn) layer. Furthermore, when indium in the In layer is replaced with the element M, the layer can be referred to as an (In,M) layer.

The CAAC-OS is a metal oxide with high crystallinity. On the other hand, a clear crystal grain boundary is difficult to observe in the CAAC-OS; thus, it can be said that a reduction in electron mobility due to the crystal grain boundary is unlikely to occur. Entry of impurities, formation of defects, or the like might decrease the crystallinity of a metal oxide; thus, it can be said that the CAAC-OS is a metal oxide that has small amounts of impurities and defects (e.g., oxygen vacancies (also referred to as V_{O})). Thus, a metal oxide including a CAAC-OS is physically stable. Therefore, the metal oxide including a CAAC-OS is resistant to heat and has high reliability.

In the nc-OS, a microscopic region (e.g., region with a size greater than or equal to 1 nm and less than or equal to 10 nm, in particular, a region with a size greater than or equal to 1 nm and less than or equal to 3 nm) has a periodic atomic arrangement. Furthermore, there is no regularity of crystal orientation between different nanocrystals in the nc-OS. Thus, the orientation in the whole film is not observed. Accordingly, the nc-OS cannot be distinguished from an a-like OS or an amorphous oxide semiconductor by some analysis methods.

Note that indium-gallium-zinc oxide (hereinafter referred to as IGZO), which is a kind of metal oxide containing indium, gallium, and zinc, has a stable structure in some cases by being formed of the above-described nanocrystals. In particular, crystals of IGZO tend not to grow in the air and thus, a stable structure might be obtained when IGZO is formed of smaller crystals (e.g., the above-described nanocrystals) rather than larger crystals (here, crystals with a size of several millimeters or several centimeters).

An a-like OS is a metal oxide having a structure between those of the nc-OS and an amorphous oxide semiconductor. The a-like OS includes a void or a low-density region. That is, the a-like OS has low crystallinity as compared with the nc-OS and the CAAC-OS.

An oxide semiconductor (metal oxide) can have various structures that show different properties. Two or more of the amorphous oxide semiconductor, the polycrystalline oxide semiconductor, the a-like OS, the nc-OS, and the CAAC-OS may be included in an oxide semiconductor of one embodiment of the present invention.

A metal oxide film that functions as a semiconductor layer can be deposited using either or both of an inert gas and an oxygen gas. Note that there is no particular limitation on the flow rate ratio of oxygen (the partial pressure of oxygen) at the time of depositing the metal oxide film. However, to obtain a transistor having high field-effect mobility, the flow rate ratio of oxygen (the partial pressure of oxygen) at the time of depositing the metal oxide film is preferably higher than or equal to 0% and lower than or equal to 30%, further preferably higher than or equal to 5% and lower than or equal to 30%, and still further preferably higher than or equal to 7% and lower than or equal to 15%.

The energy gap of the metal oxide is preferably 2 eV or more, further preferably 2.5 eV or more, still further preferably 3 eV or more. With the use of a metal oxide having such a wide energy gap, the off-state current of the transistor can be reduced.

The substrate temperature during the deposition of the metal oxide film is preferably lower than or equal to 350° C., further preferably higher than or equal to room temperature and lower than or equal to 200° C., and still further preferably higher than or equal to room temperature and lower than or equal to 130° C. The substrate temperature during the deposition of the metal oxide film is preferably room temperature because productivity can be increased.

The metal oxide film can be formed with a sputtering method. Alternatively, a PLD method, a PECVD method, a thermal CVD method, an ALD method, or a vacuum evaporation method, for example, may be used.

The above is the description of the metal oxide.

At least part of this embodiment can be implemented in combination with the other embodiments described in this specification as appropriate.

### Embodiment 3

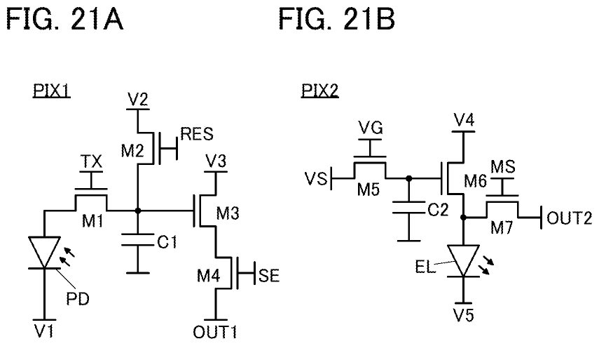

In this embodiment, a display device of one embodiment of the present invention applicable to an electronic appliance will be described with reference to FIG. 21A and FIG. 21B.

A display device of one embodiment of the present invention includes first pixel circuits including a photodetector and second pixel circuits including a light-emitting element. The first pixel circuits and the second pixel circuits are each arranged in a matrix.

FIG. 21A illustrates an example of the first pixel circuit including a photodetector. FIG. 21B illustrates an example of the second pixel circuit including a light-emitting element.

A pixel circuit PIX1 illustrated in FIG. 21A includes a photodetector PD, a transistor M1, a transistor M2, a transistor M3, a transistor M4, and a capacitor C1. Here, an example in which a photodiode is used as the photodetector PD is shown.

A cathode of the photodetector PD is electrically connected to a wiring V1, and an anode thereof is electrically connected to one of a source and a drain of the transistor M1. A gate of the transistor M1 is electrically connected to a wiring TX, and the other of the source and the drain thereof is electrically connected to one electrode of the capacitor C1, one of a source and a drain of the transistor M2, and a gate of the transistor M3. A gate of the transistor M2 is electrically connected to a wiring RES, and the other of the source and the drain thereof is electrically connected to a wiring V2. One of a source and a drain of the transistor M3 is electrically connected to a wiring V3, and the other of the source and the drain thereof is electrically connected to one of a source and a drain of the transistor M4. A gate of the transistor M4 is electrically connected to a wiring SE, and the other of the source and the drain thereof is electrically connected to a wiring OUT1.

A constant potential is supplied to the wiring V1, the wiring V2, and the wiring V3. When the photodetector PD is driven with a reverse bias, a potential lower than the potential of the wiring V1 is supplied to the wiring V2. The transistor M2 is controlled with a signal supplied to the wiring RES and has a function of resetting the potential of a node connected to the gate of the transistor M3 to a potential supplied to the wiring V2. The transistor M1 is controlled with a signal supplied to the wiring TX and has a function of controlling the timing at which the potential of the node changes, in accordance with a current flowing through the photodetector PD, or the timing at which charges generating in the photodetector PD are transferred to the node. The transistor M3 functions as an amplifier transistor for performing output in response to the potential of the node. The transistor M4 is controlled with a signal supplied to the wiring SE and functions as a selection transistor for reading an output corresponding to the potential of the node by an external circuit connected to the wiring OUT1.

A pixel circuit PIX2 illustrated in FIG. 21B includes a light-emitting element EL, a transistor M5, a transistor M6, a transistor M7, and a capacitor C2. Here, an example in which a light-emitting diode is used as the light-emitting element EL is shown. In particular, an organic EL element is preferably used as the light-emitting element EL.

A gate of the transistor M5 is electrically connected to a wiring VG, one of a source and a drain thereof is electrically connected to a wiring VS, and the other of the source and the drain thereof is electrically connected to one electrode of the capacitor C2 and a gate of the transistor M6. One of a source and a drain of the transistor M6 is electrically connected to a wiring V4, and the other thereof is electrically connected to an anode of the light-emitting element EL and one of a source and a drain of the transistor M7. A gate of the transistor M7 is electrically connected to a wiring MS, and the other of the source and the drain thereof is electrically connected to a wiring OUT2. A cathode of the light-emitting element EL is electrically connected to a wiring V5.

A constant potential is supplied to the wiring V4 and the wiring V5. In the light-emitting element EL, the anode side can have a high potential and the cathode side can have a lower potential than the anode side. The transistor M5 is controlled with a signal supplied to the wiring VG and functions as a selection transistor for controlling a selection state of the pixel circuit PIX2. The transistor M6 functions as a driving transistor that controls a current flowing through the light-emitting element EL, in accordance with a potential supplied to the gate. When the transistor M5 is in an on state, a potential supplied to the wiring VS is supplied to the gate of the transistor M6, and the emission luminance of the light-emitting element EL can be controlled in accordance with the potential. The transistor M7 is controlled with a signal supplied to the wiring MS and has a function of outputting a potential between the transistor M6 and the light-emitting element EL to the outside through the wiring OUT2.

Note that in the display device of this embodiment, the light-emitting element may be made to emit light in a pulsed manner so as to display an image. A reduction in the driving time of the light-emitting element can reduce the power consumption of the display device and suppress heat generation of the display device. An organic EL element is particularly preferable because of its favorable frequency characteristics. The frequency can be higher than or equal to 1 kHz and lower than or equal to 100 MHz, for example.

Here, a transistor using a metal oxide (an oxide semiconductor) in a semiconductor layer where a channel is formed is preferably used as the transistor M1, the transistor M2, the transistor M3, and the transistor M4 included in the pixel circuit PIX1 and the transistor M5, the transistor M6, and the transistor M7 included in the pixel circuit PIX2.

A transistor using a metal oxide having a wider band gap and a lower carrier density than silicon can achieve an extremely low off-state current. Thus, such a low off-state current enables retention of charge accumulated in a capacitor that is connected in series with the transistor for a long time. Therefore, it is particularly preferable to use a transistor using an oxide semiconductor as the transistor M1, the transistor M2, and the transistor M5 each of which is connected in series with the capacitor C1 or the capacitor C2. Moreover, the use of transistors using an oxide semiconductor as the other transistors can reduce the manufacturing cost.

Alternatively, transistors using silicon as a semiconductor in which a channel is formed can be used as the transistor M1 to the transistor M7. In particular, the use of silicon with high crystallinity, such as single crystal silicon or polycrystalline silicon, is preferable because high field-effect mobility is achieved and higher-speed operation is possible.

Alternatively, a transistor using an oxide semiconductor may be used as one or more of the transistor M1 to the transistor M7, and transistors using silicon may be used as the other transistors.

Although n-channel transistors are shown as the transistors in FIG. 21A and FIG. 21B, p-channel transistors can alternatively be used.

The transistors included in the pixel circuit PIX1 and the transistors included in the pixel circuit PIX2 are preferably formed side by side over the same substrate. It is particularly preferable that the transistors included in the pixel circuit PIX1 and the transistors included in the pixel circuit PIX2 be periodically arranged in one region.

One or more layers including one or both of the transistor and the capacitor are preferably provided to overlap with the photodetector PD or the light-emitting element EL. Thus, the effective area of each pixel circuit can be reduced, and a high-resolution light-receiving portion or display portion can be achieved.

At least part of this embodiment can be implemented in combination with the other embodiments described in this specification as appropriate.

### REFERENCE NUMERALS

10, 10a-10e: electronic device, 11a, 11b: display portion, 12: housing, 13: speaker, 14: microphone, 21a, 21a1, 21a2, 21b, 21b1, 21b2: pixel, 22, 22B, 22G, 22R: display element, 23: photodetector, 24: pixel, 25: unit, 30a, 30b: finger, 40, 40a-40d: curving portion, 50, 50a-50h, 50k: display device, 51, 52: substrate, 53: photodetector, 54: light-emitting element, 55: functional layer, 56a, 56b: support body, 57, 57B, 57G, 57R: light-emitting element, 59: light guide plate, 60: finger, 61: contact portion, 62: fingerprint, 63: image-capturing range, 65: stylus, 66: path, 67: blood vessel, 71: adhesive layer

1. A display device, comprising:
a first display region; and
a second display region,
wherein the first display region and the second display region are provided in contact with each other,
wherein the first display region comprises a plurality of first light-emitting elements and a plurality of first photodetectors,
wherein the second display region comprises a plurality of second light-emitting elements and a plurality of second photodetectors,
wherein the first photodetector has a function of receiving first light emitted from the first light-emitting element,
wherein the second photodetector has a function of receiving second light emitted from the second light-emitting element,
wherein the first light-emitting elements and the first photodetectors are arranged in a matrix in the first display region,
wherein the second light-emitting elements and the second photodetectors are arranged in a matrix in the second display region, and
wherein the second photodetectors are arranged in a higher density than the first photodetectors.

2. The display device, according to claim 1,
wherein the first light-emitting elements are arranged in a higher density than the second light-emitting elements.

3. The display device, according to claim 1,
wherein the first photodetector and the second photodetector comprise active layers comprising a same organic compound, and
wherein the first light-emitting element and the second light-emitting element comprise light-emitting layers comprising a same organic compound.

4. The display device, according to claim 1,
wherein each of the first photodetector and the second photodetector comprises a stacked structure in which a first pixel electrode, an active layer, and a common electrode are stacked,
wherein each of the first light-emitting element and the second light-emitting element comprises a stacked structure in which a second pixel electrode, a light-emitting layer, and the common electrode are stacked,
wherein the first pixel electrode and the second pixel electrode are provided on a same plane, and
wherein the active layer and the light-emitting layer comprise different organic compounds.

5. The display device, according to claim 4,
wherein the common electrode has a function of being supplied with a first potential,
wherein the first pixel electrode has a function of being supplied with a second potential lower than the first potential, and
wherein the second pixel electrode has a function of being supplied with a third potential higher than the first potential.

6. An electronic device, comprising:
the display device according to claim 1; and
a housing,
wherein the housing comprises a first surface and a second surface,
wherein the first surface and the second surface are continuously provided and have different normal directions,
wherein the first display region is provided along the first surface, and
wherein the second display region is provided along the second surface.

7. The electronic device, according to claim 6,
wherein the second surface comprises a curving surface.

8. An electronic device, comprising:
the display device according to claim 1; and
a housing,
wherein the housing comprises a bezel surrounding the first display region and the second display region, and
wherein the second display region is provided along part of an inner contour of the bezel.

9. An electronic device, comprising:
the display device according to claim 1; and
a housing,
wherein the housing comprises a bezel surrounding the first display region and the second display region,
wherein an inner contour of the bezel has a quadrangular shape or a quadrangular shape with rounded corners, and
wherein the second display region is provided in contact with adjacent two sides of the inner contour.

10. The electronic device according to claim 6,
wherein the first display region has a function of capturing an image of a fingerprint, and
wherein the second display region has a function of a touch sensor.

11. The electronic device according to claim 8,
wherein the first display region has a function of capturing an image of a fingerprint, and
wherein the second display region has a function of a touch sensor.

12. The electronic device according to claim 9,
wherein the first display region has a function of capturing an image of a fingerprint, and
wherein the second display region has a function of a touch sensor.
